(19) United States
(12) Patent Application Publication
(10) Pub. No.: US 2026/0254332 A1
(43) Pub. Date: Aug. 27, 2026

(54) Improved Reverse Magnetic Asynchronous Induction Motor Systems and Methods

(71) Applicant: Adventech, LLC, Florence, AL (US)

(72) Inventors: Gerald Goche, Myakka City, FL (US); Himanshu Verma, Florence, AL (US)

(21) Appl. No.: 19/107,540

(22) PCT Filed: Aug. 30, 2022
(86) PCT No.: PCT/US2022/042022

§ 371 Date: Feb. 27, 2025

(51) Int. Cl. H02K 17/12; H02K 1/16; H02K 3/16

(52) U.S. Cl. CPC H02K 17/12; H02K 1/16; H02K 3/16; H02K 2213/03

(57) ABSTRACT

Improved reverse-winding induction motors are presented that can achieve performance that was not previously possible and that teach new ways to configure and utilize the reverse-winding class of motors. Embodiments can present reverse-winding induction motor (1) designs that have at least one drive stator-coordinated reverse magnetic system (8), at least IE4-total motor-efficiency reverse magnetic stator system (9), at least one rated-full load slip-minimized reverse magnetic stator system (10), at least one exorbitantly-sized, reverse magnetic effect-boosting reverse magnetic stator system (24), and even at least one nearly joule effect breakdown current density reverse magnetic stator system (26). New factors and new relationships to configure reverse stator capacitor(s) are disclosed that can achieve improvements in efficiency, slip, and power factor beyond what was previously understood as the limit of performance for a reverse-winding class of induction motor.

### TECHNICAL FIELD

This patent relates to designs, systems, and methods for a particular class of induction motors, the reverse-winding induction motor. While this class of induction motors has already been shown to present motors with high-efficiency and exceptionally good power factor, this patent improves upon those advantages. Through realizations and discovery of design configurations for this particular class of induction motor, this patent discloses arrangements, systems, and methods that even further improve upon those advantages by going beyond and even discarding earlier understandings of perceived limitations. It shows that with new understandings, even higher efficiency, and better operating effects can be achieved for this class of induction motors.

### BACKGROUND

Reverse-winding induction motors represent a unique class of induction motors. Introduced in U.S. Pat. No. 7,034,426 and expanded upon in U.S. Pat. No. 7,227,288, each incorporated herein by reference, this class of induction motors was revealed to use a main or forward winding as well as, peculiarly, a secondary or reverse stator winding. Understandings of this class of motors only slowly developed. Years after introduction, additional discoveries and understandings were still significant. International PCT Patent Application US2020/013538 and International Patent Pub. No. WO2021145864 entitled “Enhanced Reverse-Winding Induction Motor Designs, Systems, and Methods”, incorporated herein by reference, revealed that new understandings were occurring years after introduction. These included at least, how such motors can be enhanced, how they can be used to correct other effects, how they can be configured, how they can be utilized in networks, and the like. These references demonstrate the unusual, not easily anticipated properties of this entire class of induction motors. U.S. Pat. No. 10,903,770 revealed there was more to be appreciated that were not mere extensions of the early understandings. That patent revealed and expanded knowledge to provide new reverse-winding induction motor designs and uses. U.S. Pat. No. 11,018,612 for Methods for Networks of Efficiently Powered Electrical Devices continued those expansions. US Patent Pub. No. 202110320605 entitled “Systems for Networks of Efficiently Powered Enhanced Reverse-Winding Induction Motor” showed how teachings and deeper understandings were often nonintuitive. Those expansions, all incorporated herein by reference, advance the state of this peculiar art and prove that their peculiar merits are appreciated through experience in application and by measuring results in actual use. Even though understandings have matured for decades since introduction, unanticipated development going beyond and sometimes shattering understood limitations continues for the reverse-winding induction motors class.

This patent disclosure shows that even further expansions are possible. It poignantly shows that, though nonintuitive to do so, at times previously stated and perceived limitations can be discarded to achieve even better performance and improved designs. The present inventions demonstrate that even now, decades after initial introduction, changes and new developments still exist that are not only unexpected but that still run counter to even previously understood limitations for this specific class of induction motors.

Accordingly, the present inventions present new and unique reverse-winding induction motor designs and methods as well as unique considerations for this particular class of induction motors.

### DISCLOSURE OF THE INVENTIONS

Accordingly, this patent discloses a variety of new designs, systems, and methods that offer advantages for reverse-winding induction motors. It presents designs and configurations that can achieve even higher efficiency, less slip, and better factors than this class of induction motor had previously achieved. Thus, one goal of embodiments of the inventions is to present improved reverse-winding induction motors that provide enhanced performance by coordinating a reverse magnetic stator system with the more traditional drive stator that exists in traditional motors not having a reverse stator winding or a reverse magnetic stator system.

Another goal of the inventions is to present reverse-winding designs that actually achieve long sought-after efficiency that is from what matters—from a total motor efficiency perspective. These now achievable efficiencies can be at levels that are espoused as standards, yet are often only previously achieved by ignoring elements or factors of what constitutes the total motor efficiency, an all-important consideration from an efficiency perspective.

In keeping with this goal, an object of the inventions is to present a motor that provides a high efficiency reverse magnetic stator system. More generally, a goal is to provide motors that actually achieve the newer standards of IE4 efficiency or NEMA super premium efficiency surprisingly from a total motor efficiency perspective. Embodiments of the inventions actually achieve the newer standards of IE4 or NEMA super premium efficiency from a total motor efficiency perspective as has not been achieved previously. Naturally this includes achieving such aspects for reverse-winding class induction motors, as well.

Yet another goal of the inventions is to provide a motor that achieves unusually low slip in a fully loaded, constantly powered condition. Naturally this includes achieving such aspects for reverse-winding class induction motors, as well.

Two other goals of these inventions fall under the category of advancing the state of the art and of the technical understandings of the entire field of reverse-winding class induction motors. First, it is a goal to shatter at least one previous limitation thought to exist for reverse-winding class induction motors. Here, a goal is to reveal that perceived limitations for the reverse magnetic stator system need not apply and to show that in fact an exorbitantly-sized element, and separately, particularly sizes reserve stator capacitors, in the system is/are beneficial. This is noteworthy because it is something that was previously understood to be inappropriate. In keeping with this goal, the inventions show that an exorbitantly-sized reverse winding capacitor is not only possible but is advantageous when appropriately chosen to achieve a reverse winding motor configured according to embodiments of the present inventions. This goal presents how such a level can be established and shows levels of performance that can be achievable when these newly discovered configurations are implemented.

Further to higher theoretical understandings in the field of reverse-winding class induction motors, a goal is to present new relationships and new factors not previously understood as being of significance for the configuration of reverse-winding class induction motors. This goal reveals not only what type of factors and relationships are in fact significant but also presents how to set beneficial values for reverse stator capacitors that enhance performance for such newly configured implementations. It includes the goal of providing alternative ways to assess and set reverse magnetic system and reverse stator capacitance values that can be applied when retrofitting or when newly designing such optimal reverse winding motors.

Naturally, other goals and objects of the inventions are disclosed throughout the text, clauses, and claims.

### BRIEF DESCRIPTION OF THE DRAWINGS

FIG. 1 depicts a cut away view of a representative motor according to some embodiments of the present inventions.

FIG. 2 is a schematic diagram of a motor, with a connection to power, according to some embodiments of the inventions.

FIG. 3 is a schematic diagram of a reverse magnetic stator system according to some embodiments of the inventions.

FIG. 4 shows a representative design having adjacent forward and reverse windings in the stator portion of a motor encased in a motor frame.

FIG. 5 is a diagram of winding wire cross sectional areas according to embodiments of the inventions.

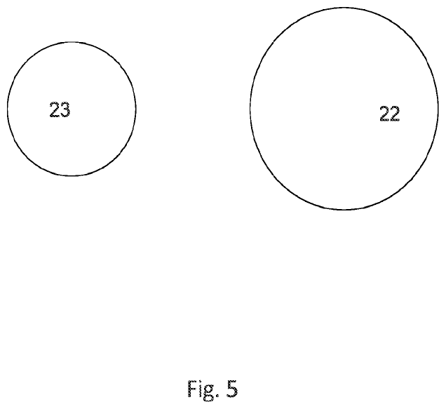

FIG. 6 is a diagram of stepped multipliers as applicable to determining and setting capacitor sizes for reverse winding motors according to embodiments of the inventions.

FIG. 7 shows tables 1 and 2 which are values for capacitors for typical frame sizes over a range of horsepower and kilowatt values.

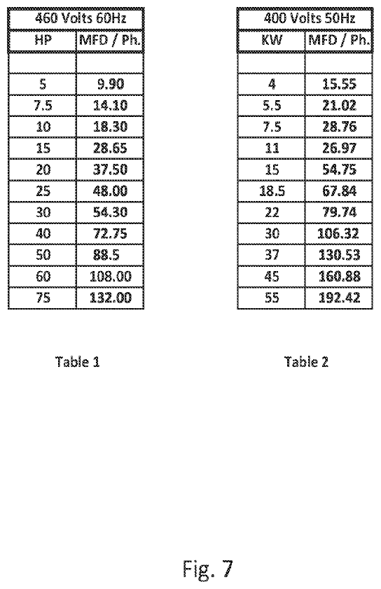

### MODE(S) FOR CARRYING OUT THE INVENTIONS

It should be understood that embodiments include a variety of aspects, which may be combined in different ways. The following descriptions are provided to list elements and describe some of the embodiments of the application. These elements are listed with initial embodiments; however, it should be understood that they may be combined in any manner and in any number to create additional embodiments. The variously described examples and preferred embodiments should not be construed to limit the embodiments of the application to only the explicitly described systems, techniques, and applications. The specific embodiment or embodiments shown are examples only. The specification should be understood and is intended as supporting broad claims as well as each embodiment, and even claims where other embodiments may be excluded. Importantly, disclosure of merely exemplary embodiments is not meant to limit the breadth of other more encompassing claims that may be made where such may be only one of several methods or embodiments which could be employed in a broader claim or the like. Further, this description should be understood to support and encompass descriptions and claims of all the various embodiments, systems, techniques, methods, devices, and applications with any number of the disclosed elements, with each element alone, and also with any and all various permutations and combinations of all elements in this or any subsequent application.

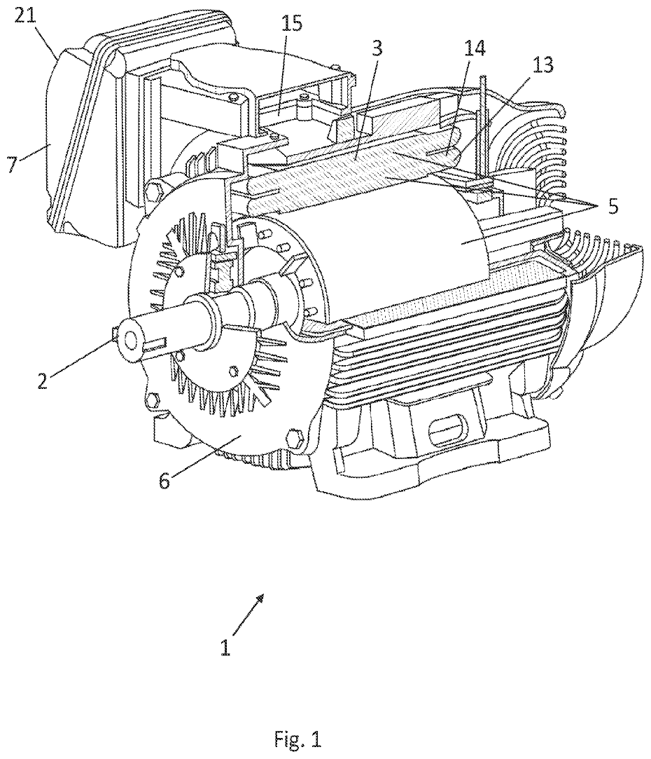

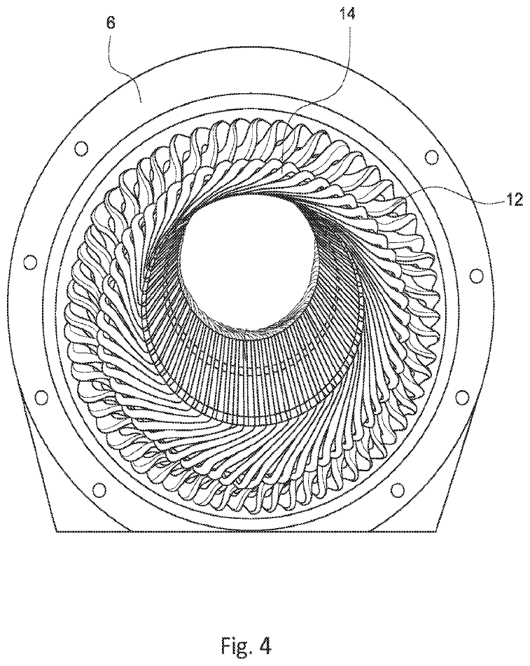

As shown in FIGS. 1 and 4, a reverse-winding electrical motor (1) operates as a typical induction motor to turn a rotor (2) by magnetic operation of a drive stator (3) that has at least one drive stator winding (4) situated therein operating in conjunction with the rotor (2). As is well known, the induction motor (1) can utilize magnetically permeable material at both the rotor (2) and the drive stator (3) which together can be considered to comprise the core (5). As is well understood, there is at least one drive stator (3) which has at least one drive stator winding (4). More commonly, there are as many drive stator windings as there are electrical AC power supply phases. Most commonly a three-phase system has three drive stator windings (4). This is also true of the reverse stator windings (14) and the reverse magnetic stator system (13) as discussed later. Accordingly, the drive stator (3) with its at least one drive stator winding (4) can be considered a forward winding or forward magnetic system.

As also common in standard induction motors, the rotor (2), and drive stator (3) are contained in an encasement or motor frame (6). This motor frame (6) typically encases at least the at least one drive stator (3) and the rotor (2). In the reverse-winding class of induction motors, the motor frame (6) can also, and typically does, encase at least parts of the at least one reverse magnetic stator system (13) and one of its components, the reverse magnetic stator (via reverse stator winding (14)). Thus, as can be appreciated, the reverse magnetic stator system (13) can include at least one reverse stator winding (14).

As discussed later, noteworthy is that the industry has evolved with a standardized motor frame sizing. For standard induction motors, these standardized motor frame sizes can, and generally do, establish the properties of the motor-its horsepower or kilowatts, and for particular voltages, its full rated load current, its efficiency, and the like. Such motor frames (6) are presently standardized by standard setting bodies such as NEMA and IEC. Embodiments of the present inventions show that some of those predetermined values are not appropriate for this class of motors and certainly not for such motors according to embodiments of the present inventions. Thus, the present inventions can be viewed to at least some degree as breaking the long-accepted paradigm that all motors have similar operating characteristics.

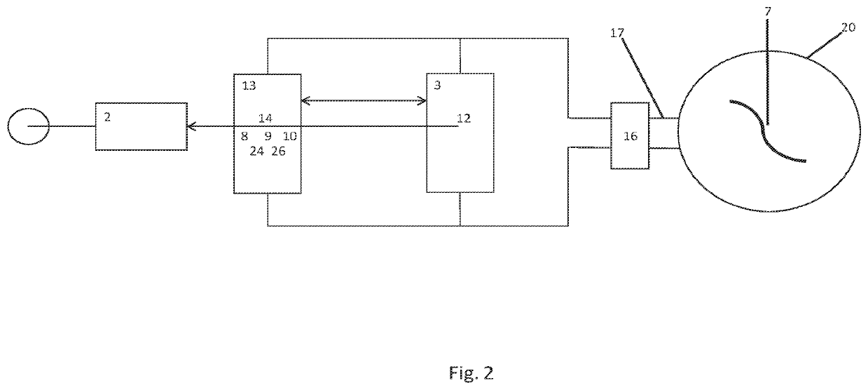

In operation and as shown beginning in FIG. 2, the induction motor (1) is operated by providing electrical connection (17) to a source of power (7). This source of power (7) is typically a public power source such as the grid (20). The grid or other power source acts to achieve powering of the at least one drive stator (3). The drive stator (3) acts on the rotor (2) to rotate the rotor (2) through interaction of the drive stator (3). In the reverse-winding induction motors class of motors, the source of power (7) can also power at least one reverse magnetic stator system (13). This can include powering or energizing the reverse magnetic stator system (13) and the reverse stator winding (14). As to more general operations, powering of the induction motor (1) often involves an induction motor drive system (16). The induction motor system drive system (16) can act to alter how the motor operates in known manners. It can be a variable frequency drive (VFD) for speed adjustment and control, it can alter power factor, it can correct power effects, and the like. Such drive systems (16) can be used on both traditional induction motors and on the reverse-winding class of induction motors.

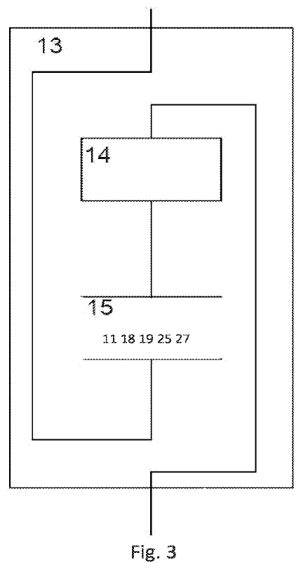

As mentioned above, traditional induction motors have what can sometimes be referred to as at least one forward winding (12). In addition to the at least one forward winding (12), the reverse-winding class of induction motors have at least one reverse magnetic stator system (13) which may, and does include at least one reverse stator winding (14). Adjacent forward (12) and reverse stator windings (14) are shown in FIG. 4. Co-wound forward and reverse stator windings can also be utilized. As shown through the connection diagram in FIG. 3, the reverse stator winding (14) can be configured or connected as an opposite direction winding to the forward winding (12) in that it presents an opposite direction magnetic field. This can just be by reverse connection. Thus, such motors can present opposite direction winding electrical motors, and motors according to the present inventions can have at least one drive stator opposite winding. The opposite magnetic direction windings can thus act in a reverse fashion. Motors according to the present inventions can have generally at least one magnetically contravening reverse stator winding in that the magnetic field of the reverse stator is to some degree contrary to some other element in the motor, such as magnetic field, to achieve the desired effects. They can also have at least one substantially drive stator magnetically coincident reverse stator winding (14) in the sense that the two magnetic fields happen at least partially at the same time (i.e., accounting for current phase differences), are proximate and may be adjacent, and are in agreement or harmony in the sense that they work together to cause the desired effects of not only driving the rotor but of achieving the improved efficiency, improved slip, improved power factor, or otherwise coordinate as desired.

FIG. 3 depicts a single reverse magnetic stator system (13). The reverse magnetic stator system (13) includes at least one reverse stator winding (14) (there are often three for three phase power supplies). The at least one reverse magnetic stator system (13) also can include at least one reverse stator capacitance (15) or more generally, a capacitor. As now more fully appreciated and understood for the reverse-winding class of induction motors, this at least one reverse stator capacitance (15) can be vital to the improved operation now discovered for the reverse-winding class of induction motors. As mentioned later, by appropriately selecting the capacitance value for each of the reverse stator capacitances (15), significant advantageous can now be realized. Again, as with the reverse windings, there are often three reverse stator capacitances (15) for three phase power supplies and the like. Finally, it may be noted that for this class of induction motors, the at least one reverse stator winding (14) can often be referred to as a generator winding because it is reverse and thus like a motor-generator can be considered as effecting results akin to that of a generator. Importantly, in this class of motors, the rotor is rotated with interaction of the at least one drive stator (14) and the at least one reverse magnetic stator system (13).

With this background, it can be further understood how the inventions present an improved reverse magnetic asynchronous induction motor system and how they present a method of providing power from an asynchronous induction motor system or a method of providing power from a reverse magnetic asynchronous induction motor system. These two parallel perspectives, that of apparatuses, namely motor systems, and that of a processes or methods, namely methods of providing power from a motor show how the inventions can be described in apparatus claims or method and process claims as well. Discussions in this patent-whether provided in apparatus element language or in method step language should be understood as supporting both. For example, in the above, the electrical connection (17) to a source of power (7) should be understood as encompassing the steps of electrically connecting, and the steps of providing at least one electrical motor, and the steps of powering the device as one of ordinary skill in the art should well understand.

As mentioned, one of the goals of one embodiment of the inventions focuses on the aspect of having a drive stator-coordinated reverse magnetic system (8). This understanding and discovery is significant because it changes the entire paradigm of considering how to design such motors and now shows there are ways to optimize the class of reverse-winding induction motors beyond their already significant advantages. This aspect of the inventions shows that previous perceptions of limits in designing the reverse magnetic stator system (13) in this class of motors are not actually limits. To the extent limits were thought to exist dependent on current and voltages anticipated for the reverse magnetic stator system (13), those limits are no longer necessary. Further, new advantages can be achieved by now designing for other criteria and ignoring prior perceived limits. And as a result, prior teachings that were viewed as limits are, to some degree, no longer appropriate.

As shown in FIG. 2, in some embodiments, the at least one reverse magnetic stator system (13) can be configured and viewed as at least one drive stator-coordinated reverse magnetic stator system (8). This type of modeling and sizing criteria is particularly useful when there is a totally new design with no prior frame values to utilize. As well known, the reverse magnetic stator system (13) has reverse reactance. This may be as a result of the reverse stator winding (14) as well as the reverse stator capacitance (15), among other factors as is well-known in the art. In most reverse-winding class induction motors, a very significant factor is the reverse stator capacitance (15) as it can govern current and effects of the reverse magnetic stator system (13). Because the entire field of reverse-winding class induction motors is not under-pinned with extensive mathematical foundations and is to a significant degree empirical, the perspective of having at least one drive stator-coordinated reverse magnetic system (8) is a significant realization. And it is a realization that allows (often through trial and error and empirical understandings) significant increases in performance that had not previously been expected to be attainable, that are nonintuitive, and that the prior art taught away from. As mentioned, equivalent circuits and some estimates of performance and optimal parameters may eventually be developed and proven, but at the present stage, no assuredly accurate theoretical modeling for the precise reverse-winding magnetic stator systems (13) involved, can be shown with confidence to a degree that they are unquestionably accurate and in no way misleading, so tabular values are provided. Instead, the key that is known is that coordinating aspects such as one or more capacitor reactance and reverse winding reactance with such factors (reactance, etc.)—among others—of the drive stator (3) represent unusual advancements. These are not just advancements of degree. From some perspectives, these may ultimately be viewed as providing a reverse magnetic stator system (13) that acts to compensate, to enhance, to oppose, to generate, or to cancel (to some degree) effects from the drive stator (3) in order to achieve significant advances in performance of the entire motor (1). From this perspective, the reverse magnetic stator system (13) {used in the singular but throughout it and other similar terms are meant in the “at least one” context} can act as and be configured as a drive stator-coordinated reverse magnetic stator system (8). Similarly, as shown in FIG. 3, the reverse stator capacitance (15) can act as and be configured a drive stator-coordinated capacitance (18). Optimum values can be, and are, most accurately set through trial and error or by empirical testing. By powering the drive stator-coordinated reverse magnetic stator system (8), then rotating the rotor (2) with interaction of the drive stator (3) in conjunction with the drive stator-coordinated reverse magnetic stator system (8), improved performance can be achieved. Once other elements of the motor are set, this can be accomplished by adjusting the drive stator-coordinated capacitance (18) to get the desired performance from that particular motor configuration.

Yet another goal of another embodiment of the inventions focuses on the aspect of having (at least one) at least IE4-total motor-efficiency or NEMA super premium-total motor-efficiency reverse magnetic stator system (9). An interesting attribute of embodiments of the inventions is that perhaps for the first time through these inventions, at least IE4-total motor-efficiency can actually be achieved by the motor alone. While other manufacturers tout having IE4 efficiency, upon thorough understanding it can be understood that their touted efficiency is generally not a “total motor-efficiency”, that is efficiency without consideration of any drive (16) element, any efficiency defined apart from any network, any ancillary components, and thus efficiency of truly the total motor in isolation. For example, in some situations, total motor efficiency can be considered as that using apparent power, namely true power plus reactive power or complex power and the like. Surprisingly, through this embodiment of the inventions, lone motor, full load, total motor-efficiency can now be achieved at or above the IE4 or NEMA super premium established levels. As mentioned, this is achieved by providing a reverse-winding induction class of motor and configuring the reverse magnetic stator system (13) as a IE4-total motor-efficiency reverse magnetic stator system (9) and perhaps configuring the reverse stator capacitance (15) as an at least IE4-full-system-efficiency capacitance (19). Again, this can be done empirically to set components such as the reverse stator winding (14) and the reverse stator capacitance (15) to get the desired efficiency and to establish them as an at least IE4-total motor-efficiency reverse magnetic stator system (9) and an at least IE4-full-system-efficiency capacitance (19). As with the drive-stator coordinated embodiment, by powering the at least IE4-total motor-efficiency reverse magnetic stator system (9), including or as caused by the at least IE4-full-system-efficiency capacitance (19), and then rotating the rotor (2) with interaction of the drive stator (3) in conjunction with the at least IE4-total motor-efficiency reverse magnetic stator system (9), improved efficiency- and notable total motor-efficiency at or above the IE4 levels can be achieved. All the same is possible for NEMA super premium levels as well, of course.

When considering efficiency and the newer levels set, it can be important to understand the impact of the standardized encasement or frame (6). That sizing—as set by standard setting bodies such as NEMA and IEC—traditionally governs performance based on the type of motor (poles/speed, voltage, supply frequency, etc.). From this perspective, the frame establishes not only the hp or kW rating of the motor, but also its otherwise efficiency. This often exists through a nameplating process where each motor has a nameplate (21) that specifies numerous parameters. While these could be viewed as minimums, for economic and other reasons, they are often de facto the only values that are met. And if one manufacturer did not meet those standard nameplate (21) values for that size frame (6) with that type motor and those conditions (voltage, frequency, etc.), their motor would not sell. Interestingly, this nameplating process is done by standard setting bodies such as NEMA and IEC based on standardized encasement or frame (6) sizes. The newer efficiency levels of IE4 efficiency are established such as by the IEC's International Energy-efficiency classes (IE Codes) as in IEC Standard 60034-30 as last revised in 2014, IEC/EN 60034-30-1:2014, NEMA 10011-22. And NEMA has conceptually similar values and has an efficiency standard similar to the IEC's IE4 level, called “Super-Premium” efficiency. In the context of embodiments of these inventions, the term high efficiency for such reverse magnetic stator systems should be understood to encompass similar IE4 or NEMA super-premium levels and NEMA frame sizes by analogy.

As to some present embodiments, values of efficiency, slip, and even power factor are given relative to the more traditional, non-reverse winding class of motors. When used as a comparative, terms such as the ‘at least IE4-total motor-efficiency’ termed reverse magnetic stator system (9), is used to compare these embodiments of the present inventions with a non-reverse-winding induction motor class of a comparable motor, that is a motor with the similar nameplating parameters (frame, poles, rpm, voltage, frequency, etc.) but without the changes that make it a reverse-winding class motor. Changes such as needed to provide space for and insert a reverse magnetic stator system (13) are not included but everything else is as a standard motor including operating conditions. For example, a NEMA frame size of 184T can have nameplate parameters of: HP 5, RPM 1748, Enclosure TEFC, Des B, Frame 184T, Amps 7.0, PH 3, HZ 60, Duty Cont, Volts 460, Type P, Amb 40 C, SF 1.15, INS CL F, EFF 82.5, P.F. 80, DE bearing 35BC02JGG30A26, ODE bearing 3OBC02JGG30A26. This nameplate indicates that this motor is a 5 hp motor that operates at 82.5% efficiency. If this motor were made into a reverse-winding class of induction motor it would be against this 82.5% efficiency that the new motor according to embodiments of these inventions, and operating similarly, (e.g., a 5 hp motor at 460V, 60 Hz, 3 phase) would be compared and the efficiency improvement perhaps quantitatively stated. The myriad of factors that go into determining what is the promised nameplate values are well known, are calculatable from design or signature analysis software, can be newly derived, and for existing frames are published in various nameplate explanations and standards, and these are considered in assessing what is a comparable motor and how improvements are quantitatively determined.

In further understanding the improvements of embodiments of the present inventions, it is also important to understand how improvements exist and how hard they are to attain when the levels of performance are already high. While such embodiments of the present inventions can add efficiency of 3-5 absolute points for larger motors (over 100 Hp), and can add 5-7 points for smaller motors, these estimates are rough values. Instead, percent-to-perfect is a better perspective. For example, for a motor already at 94% efficiency, it might seem like adding an absolute additional 2 points to efficiency—from 94% to 96% ought not be that difficult, but in fact this needs to be viewed from a perspective of how much those two points add to the remaining six percent. Adding two points to an already 94% efficient motor is vastly different from adding two points to an already 82.5% efficient motor. Those two points for a 94% efficient motor represent a 33% improvement (33% to perfect, or 100% efficient). Thus, it is the delta to perfect, 100% efficiency and how difficult those last few percentage points are to achieve that is the key. So, the perspective that most puts that difficulty into conceptual understanding is the percent from the existing or non-invention altered motor level to perfect. From 94% to 100% while only 6% is hard and in fact likely impossible for an isolated motor. So, the thirty-three percent improvement on that 94% (toward 100% or perfect) is merely 2% yet that amount is really huge, and is more appropriately understood as a thirty-three percent, 33%, improvement over the 94% existing amount. In this context, several types of improvements can be understood for the advantages of embodiments of these inventions: efficiency improvements, slip improvements, power factor improvements. Each is discussed in turn. And interestingly while some improvements to ‘perfect’ represent difficult levels of achievement, some can in fact be achieved (such as power factor which is a special element for reverse-winding class of induction motors, hence one reason they deserve to be in a class all by themselves).

In the context of the embodiments that include an at least IE4-total motor-efficiency reverse magnetic stator system (9) or the like, and a total motor efficiency improvement to at least IE4 standards, levels achieved can be understood best from a motor frame having a comparable motor standard nameplate efficiency value at a rated full load when the motor system motor frame (or its substantial equivalent if a newly designed frame) is used without the reverse magnetic stator system (i.e., traditionally) in a comparable motor nameplate (21) circumstance. Thus, constant power efficiency at its rated full load that improves upon a comparable motor standard nameplate efficiency value by at least a 20% efficiency improvement over that amount towards perfect, or 100% efficiency (e.g., 85% to 88%, or 95% to 96%) and other values are possible. Here, embodiments can achieve such a 20% improvement, a 33% improvement, a 40% improvement, and even a 50% improvement (e.g., 80% to 90%, or 94% to 97%), all as compared to a comparable motor system motor frame when used without a reverse magnetic stator system in such a comparable motor. Here it can be understood that with the teachings of the present inventions and by going beyond previous perceived limits, such percentage-to-perfect improvements with respect to efficiency can be achieved. In setting an appropriate at least IE4-total motor-efficiency capacitance (19) or the like, in providing an at least IE4-total motor-efficiency reverse magnetic stator system (9) or the like, and even in providing at least one efficiency optimizing reverse magnetic stator system, motor efficiency may be optimized for “high efficiency”, even if more is achievable, and even if the optimization does not achieve perfect total motor efficiency.

Similar to the percent-to-perfect approach, absolute values of efficiency can be set for motors of a given power and other conditions, too. In this regard, a total motor efficiency at constant power, and at 100% of rated load can be selected from: at least 98.5% efficiency for motors having rated full loads above 2 megawatts, at least 99% efficiency for motors having rated full loads above 2 megawatts, at least 98.5% efficiency for motors having rated full loads from 1 megawatt to 2 megawatts, at least 99% efficiency for motors having rated full loads from 1 megawatt to 2 megawatts, at least 98% efficiency for motors having rated full loads from 500 kilowatts to 1000 kilowatts, at least 98.5% efficiency for motors having rated full loads from 500 kilowatts to 1000 kilowatts, at least 97.5% efficiency for motors having rated full loads from 100 kilowatts to 500 kilowatts, at least 98% efficiency for motors having rated full loads from 100 kilowatts to 500 kilowatts, at least 97% efficiency for motors having rated full loads from 20 kilowatts to 100 kilowatts, at least 97.5% efficiency for motors having rated full loads from 20 kilowatts to 100 kilowatts, at least 96.5% efficiency for motors having rated full loads from 5 kilowatts to 20 kilowatts, at least 97% efficiency for motors having rated full loads from 5 kilowatts to 20 kilowatts, at least 96% efficiency for motors having rated full loads from 1 kilowatts to 5 kilowatts, at least 96.5% efficiency for motors having rated full loads from 1 kilowatts to 5 kilowatts, to name a few. Similarly, efficiency characteristics that represent a move towards perfect efficiency that exceeds a specific current IEC/EN 60034-30-1:2014 IE4 efficiency standard for that motor type when said motor system motor frame is used without a reverse magnetic stator system in a comparable motor by an improvement toward perfect efficiency selected from at least a 20%, 33%, 40%, and 50% efficiency improvement toward perfect efficiency as compared to said IEC/EN 60034-30-1:2014 IE4 efficiency standard for a comparable motor can be achieved.

Similar to the improvements in efficiency just discussed, embodiments can be configured to improve slip (i.e., less slip under given, usually full rated, load). Again, this can be considered from the percentage-to-perfect improvement perspective and otherwise. Here, embodiments can include at least one rated-full load slip-minimized reverse magnetic stator system (10), and perhaps at least one slip-minimized capacitance (11). Again, this can be done empirically to set components such as the reverse stator winding (14) and especially the reverse stator capacitance (15), as the slip-minimized capacitance (11), to get the desired slip and to establish them as at least one rated-full load slip-minimized reverse magnetic stator system (10), and at least one slip-minimized capacitance (11). As with the other embodiments, by powering the at least one rated-full load slip-minimized reverse magnetic stator system (10), including or as caused by the least one slip-minimized capacitance (11), and then rotating the rotor (2) with interaction of the drive stator (3) in conjunction with the at least one rated-full load slip-minimized reverse magnetic stator system (10), improved slip performance can be achieved. Again, levels achieved can be understood in the context of a motor frame having a comparable traditional, non-reverse winding induction motor standard nameplate or otherwise determined slip value (usually the difference between the comparable motor nameplate (21) rpm at a rated full load subtracted from the no load drive speed expected (set by the poles and the line frequency and usually obvious from the nameplate load rpm) when the motor system motor frame is used without the reverse magnetic stator system (i.e., traditionally) in a comparable motor nameplate (21) circumstance. Here the embodiments of the present inventions improve upon prior reverse winding motor designs and go beyond previously expected limitations. Thus, for a motor frame having a comparable motor standard nameplate slip value at a rated full load when that motor frame is used without a reverse magnetic stator system in that comparable motor, slip at rated full load can improves upon the comparable motor standard nameplate slip value by at least a 20%, 50%, 75%, 90%, and 95%, slip improvement over that amount towards zero slip (e.g., the delta to perfect). Such values can also be achieved for less loads such as 75% rated load. And as with efficiency, absolute amounts of slip improvements exist. Here, such embodiments can achieve less than 0.5%, 0.3%, or 0.1% slip at greater than 75% of its rated full load, and similarly less than 0.5%, 0.3%, 0.1%, an even 0.06% slip at some motor's rated full load.

Next one can even consider power factor-whether from the percentage-to-perfect improvement perspective or otherwise. Again, each motor frame usually has a comparable motor standard nameplate power factor value at a rated full load when that motor system motor frame is used without a reverse magnetic stator system in a comparable motor and motor conditions. Setting the reverse magnetic stator system (13) and/or the reverse stator capacitance (15) empirically or otherwise as above, embodiments here can achieve a constant power, power factor at rated full load that improves upon the comparable motor standard nameplate power factor value by a power factor improvement selected from at least a 20%, 50%, 75%, 90%, and even 100% (i.e., power factor 1.0!) power factor improvement over a comparable motor standard nameplate power factor towards 1.0 power factor (e.g., the delta to perfect).

As mentioned, setting the reverse stator capacitance (15) is an important element in configuring reverse winding motors according to embodiments of the inventions. An aspect that can be important in determining an appropriate reverse stator capacitance (15) can be the fact that the forward winding (12) and the reverse stator winding (14) can have different winding wire cross-sectional areas. This is accomplished to allow fitting the reverse stator winding (14) in the frame (6). Here, the ratio of the forward winding-wire cross sectional area, or the drive stator wire cross-sectional area (22), to the reverse winding-wire cross sectional area, or the reverse stator winding wire cross-sectional area (23), can establish a ratio of about two. This can represent a practical compromise of space, reactance, and effect for the class of reverse winding induction motors. It is with this ratio that many potential values are explained, although not believed to be a limit unless expressly stated.

As mentioned earlier, previous reverse winding motor component limits are now shown not to be mandatory. Even previously understood relationships are now shown not to be optimal. By overcoming prior limits and designing to newly understood relationships, new levels of performance can be achieved. This is most evident in the limits and the design relationships expected for the reverse stator capacitances (15) to be optimal. These understandings and discoveries are significant because they change how to optimally configure such components for these motors. Importantly, the values discovered to be optimal are significantly different from those previously thought to be appropriate. First, these new values go beyond previous limits. And for certain situations they are as much as one and even two orders of magnitude different. This can yield significant improvements in performance particularly in realms (such as efficiency) that asymptotically approach ideal values where a percent-to-perfect perspective is relevant such that small improvements represent large, and increasing, percentage improvements. Second, these new values are based on totally different relationships than previously understood. These new relationships reveal that optimal designs need reverse stator capacitances (15) that vary based on different parameters and even in particular voltage ranges. This aspect of the inventions shows that previous relationships and previous understandings of limits in configuring the reverse stator capacitances (15) for a reverse magnetic stator system (13) in this class of motor are no longer required and actual components are drastically (sometimes orders of magnitude) different than previously applied.

The unusual character of going beyond those perceived limits is nonintuitive, as those prior limits teach away from embodiments of the present inventions. Again, this is not just a matter of degree; it is different relationships that provide for sometimes drastically different sizing of the one or more reverse stator capacitances (15). As is well understood for reverse-winding induction motors, the at least one reverse stator winding (14) can be connected to at least one capacitor (15). Usually one capacitor (15) is connected in series with each of the reverse stator windings (14). Surprisingly, to achieve the new goals and attain a new type of reverse magnetic stator system (13), and/or a new type of reverse stator capacitance (15), as set forth for the various embodiments, previous limits and relationships need to be discarded. Now in view of this present discovery, embodiments can include an exorbitant capacitor, that is, one that is greater than previously taught and without the previous maximum limiting value. In such embodiments, the inventions can be presented as involving motors that have at least one reverse stator winding (13) that is configured as at least one exorbitantly-sized, reverse magnetic effect-boosting reverse magnetic stator system (24) that to any degree exceeds that supposed limit, performance can be enhanced and improved. By configuring at least one reverse stator capacitance (15) as at least one exorbitantly-sized reverse magnetic effect-boosting capacitance (25), embodiments can achieve the mentioned performance. Quantitatively, in some of those embodiments this is a reverse stator capacitance (15) having a microfarad value as set forth in Tables 1 and 2. It can be more precisely determined by relationships discussed later. Such values are not known to have ever been tried previously (of course, this is a new relationship and accidental efforts are not well known), but these values are remarkable because they yield significant improvements. The at least one exorbitantly-sized reverse magnetic effect-boosting capacitance (25) can be sized as having a capacitance value in microfarads (MFD or μF) as shown in the Tables for the stator coordinated configuration, or via the relationships discussed later.

The teachings in U.S. Pat. No. 10,903,770 established (albeit empirically as much of this class of motors has been developed) that it would be wrong to exceed a value of a particular value. In fact, the present disclosure teaches, first, that such a limit is not optimal for maximizing performance and actually limits achievable performance for the reverse-winding class of induction motors. Second, the present disclosure teaches that, unlike the prior teachings, even the use of a multiplier is not optimal if it is a constant value over a range of designed reverse winding motor voltages. Third, it teaches that, unlike the prior teachings, even the prior complex conjugate or conjunctive term is suboptimal. First, using a range multiplier that is very different and ultimately ends up with a capacitance value that exceeds the previous “limit” is not prohibited—it is better. Second, the new range multiplier is not a steady value but varies within a peculiar voltage range in a ramped-step up fashion. Third, the prior complex conjugate or conjunctive term is replaced with a significantly new relationship—and one that, surprisingly and nonintuitively for retrofit designs or designs using an existing frame, relates the reverse winding parameter to the frame when used for other than the reverse winding motor. This type of new relationship yields very different values and very different performance. Where the prior art taught a set multiplier, the new disclosure teaches that, using afar different multiplier and one that ramps up over a particular motor supply voltage range (from 900V to 2300V) is actually better for motor performance. Noteworthy in this regard is that the prior art taught a maximum reverse stator capacitance (15) value in microfarads equal to that old maximum multiplier times, the operational nominal motor current in amps of the motor, times, a ratio, times, the rated full load motor current in amps of the motor for that RMS rated optimal operational motor voltage. Now, the new present disclosure reveals that an optimal capacitor sizing can from one model actually be derived from a different, and variable, range multiplier, times different factors of, for that model, a different motor. Those factors can include power, voltage, efficiency, and power factor of a different motor. And surprisingly the efficiency and power factor parameters are not even values that will apply to the ending reverse winding motor. According to this new aspect of the inventions, it has been discovered that reverse winding motors and their performance can be optimized. This is accomplished by appropriately setting the reverse stator winding capacitor (15) to new values. The new relationship is even one that can be understood with varying degrees of refinement.

The new relationship for existing frames can be understood in a sequenced fashion. Initially, the motor can be understood to have each phase's reverse stator capacitance (15) with a microfarad value that is sized at about values determined by parameters for a comparable supplied (similar voltage and frequency) power, and for some aspects number of poles, but disparate motor type induction motor. Interestingly, some of these parameters are ones that are inapplicable to the improved reverse magnetic asynchronous induction motor. Such parameters can be determined from known design criteria and calculations for standard comparable motors. As one example, these parameters can be determined using traditional (non-reverse winding) relationships perhaps as calculated by an induction motor design or analysis software such as the Ansys Maxwell™ software as currently available from ANSYS, Inc., and as derived from electrical signature analysis (ESA) software such as the ALL-TEST PRO™ software or that On-Line III™ software as currently available from ALL-TEST Pro, LLC. It can also be determined from the nameplate that would typically be found on that frame. By this new relationship, more optimal capacitance values can be determined by nameplate parameters of the disparate motor type induction motor. Several parameters can be used. Capacitance size can be determined at least in part by the nameplate voltage of the disparate motor type induction motor, at least in part by the inverse cube of the nameplate voltage of the disparate type induction motor, at least in part by the nameplate power of the disparate motor type induction motor, at least in part by the nameplate efficiency and power factor of the disparate type induction motor, at least in part by the inverse of a quantity equal to the nameplate efficiency times the nameplate power factor of the disparate motor type induction motor, and at least in part by a multiplier times a value determined by the nameplate parameters of the disparate motor type induction motor. While each of these can be sequenced into the relationship, a preferred ending relationship is one that determines the capacitance value(s) as each value having a microfarad value substantially equal to a stepped variable multiplier stepping over a specific nameplate voltage range, times the frame's standard nameplate motor power in watts, times the inverse of a quantity equal to: the frame's standard nameplate motor voltage in volts cubed, times the frame's standard nameplate motor efficiency as a decimal value, times the frame's standard nameplate motor power factor as a decimal value.

Three facets are noteworthy and unusual in this regard. First, this relationship equates the absolute values of at least three dimensionally distinct and not expected to be relatable units, namely, microfarads with watts and inverse volts cubed. The value of some motor's particular composite values yields the reverse stator capacitance (15) in the units of microfarads (μF often referred to as MFD). As but two examples using preferred multipliers, if the appropriate motor frame's ratings were 5 hp (3730 watts), at 460 volts with an efficiency of 89 percent (0.89 as a decimal) and a power factor of 83 (0.83 as a decimal). a capacitor of 10.6 MFD is optimal. Likewise if another appropriate motor frame's ratings were 700 hp (522,000 watts), at 3300 volts with an efficiency of 95.5 percent (0.955 as a decimal) and a power factor of 88 (0.88 as a decimal). a capacitor of 27.1 MFD is optimal. As mentioned below this may be plus or minus 10%.

Next, for this model, it is not even the type of motor being designed that provides guidance, it is not a reverse winding motor, it is a totally different motor based on the frame size chosen for design or configuration. A disparate motor, meaning a motor distinct in kind is what is used to find the MFD value that sets the capacitance of a very different motor. The capacitance has a size determined by a comparable supplied power but disparate motor type induction motor.

That a nonanalogous motor sets the value for this model and sizing criteria is surprising. For retrofits and for designs using a set motor frame, the pre-reverse winding designed motor that uses that particular frame determines the reverse stator capacitor's (15) initial sizing. While that non-reverse winding motor is comparable in that it has a similar power and voltage, it is still a different motor and even uses non-applicable efficiency and power factor values because the ending reverse winding motor will have far better efficiency and far better power factor. As is well known, motors usually have a nameplate with various parameters when used as a standard, non-reverse winding motor. These are the values that are used in assessing the configuration of the reverse winding motor reverse stator capacitor (15) values when using this model. For new designs, where there is no pre-existing frame, similar frames can be used or a separate model, that of stator coordination is provided. Both models yield similar values and results and so the about or substantially equal to qualifiers are appropriate.

As mentioned, for the disparate motor model, a further refinement of the relationship is that of using a particular type of multiplier to determine the optimal size for the reverse stator capacitors (15) in the reverse winding motor. As can be appreciated from the above, in initial embodiments, this multiplier can vary by the voltage of the nameplate or calculated supplied power. A voltage variable multiplier is preferred for some embodiments. And as mentioned below, sizing can go up achieve a nearly joule effect breakdown current, and this a nearly joule effect breakdown capacitance. In this upper bound situation, the capacitor(s) microfarad value can be up to nearly a capacitance value that effects a joule effect breakdown current density in a reverse winding or more generally in the reverse magnetic stator system (13).

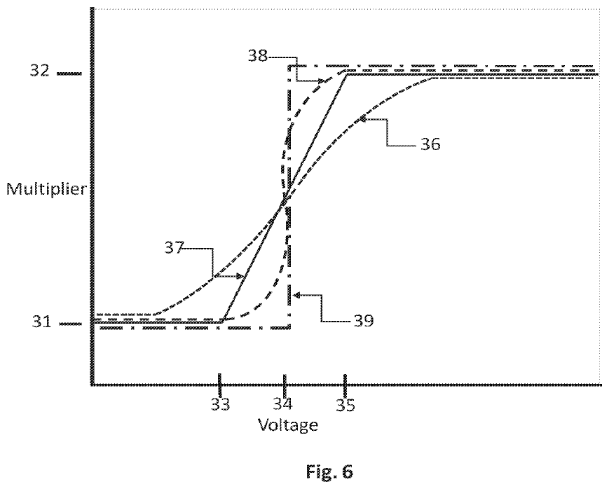

Another new aspect relative to the reverse stator capacitor(s) (15) sizing is that the multiplier can, for some embodiments, be a multiplier that varies with some parameter or parameters. Examples of this are shown in FIG. 6. In a preferred embodiment of these inventions, the multiplier is a supply voltage variable multiplier in that it varies based on the frame's nameplate voltage. Thus, the multiplier can be considered a voltage variable multiplier.

In yet further embodiments, it has been discovered that variation of the multiplier can be stepped, such as in a step function (39) at one location as shown in FIG. 6 on the step function line (39), or in a stepped fashion that merely changes multiplier values over a range as shown by all curves in FIG. 6 (these being but a few of the possibilities). Generally, such embodiments can include a stepped variable multiplier. This can go from a lower level (31) to an upper level (32). As before, this can apply to all multiplier options, so for example in the seemingly most desirable base or lover level (31) multiplier, there can be an about one hundred eighty-three thousand lower step multiplier value. An upper level (32) can be an about about one million three hundred fifty-eight thousand upper step multiplier value. Naturally this relationship can be altered for a change in units (horsepower to kilowatts, and microfarads to farads, etc.) but such known quantitative changes are equivalent to that discussed here. Further, for determining capacitance values, it should be understood that the terms “about” and “substantially equal to” can be narrowed quantitatively to values within ten percent (10%) or fifteen percent (15%) of the initially determined value.

Interestingly in the context of some embodiments, the variation can be and is currently preferred to be restricted to a particular voltage range. Thus, embodiments can present a supply voltage range variable multiplier. And even further, within this range the multiplier can go up in a variety of fashions, thus generally presenting a supply voltage range ramped up variable multiplier. The ramping can be limited to a particular supply voltage range in that the values outside of that range (outside of (33) and (35)) are relatively constant at an upper (32) or lower level (31). Thus, embodiments include a limited voltage range ramping variable multiplier. Again, the range and values can be empirically determined, however, at present preferred embodiments of the inventions have an about nine hundred volt lower ramp range value and an about twenty-three hundred volt upper ramp range value. This is as more generically shown in FIG. 6. In the variation regime or range, the change can be linear such as shown in the linear sloped line (37). Slope can vary but this depicts a linearly varying stepped multiplier. Other lines such as (36) and (38) depict smoothed versions where known smoothing techniques can be applied in various ways.

Both of these are some of a more general group where there is a smoothed step multiplier. All of these can be accomplished in particular ranges such as the 900V to 2300V range mentioned earlier. As such there can be a linear voltage range ramping variable multiplier, and a smoothed range ramping variable multiplier. The center of the variation (34) be it a step, a linear ramp, or a smoothed step multiplier can be at various values, including but not limited to the 900V value, the midpoint of the range value, a 1550V value (as depicted in line (34) in FIG. 6), or even at the 2300V value. Thus using the depiction perhaps interpreted as at 1550V as but one example, there can be a ramp centered on about a 1550V value.

As mentioned above, the reverse stator capacitance (15) value can be up to a value up to nearly a capacitance value that effects a joule effect breakdown current density in said reverse winding. By powering the at least one exorbitantly-sized, reverse magnetic effect-boosting reverse magnetic stator system (24), including or as caused by the at least one exorbitantly-sized reverse magnetic effect-boosting capacitance (25), and then rotating the rotor (2) with interaction of the drive stator (3) in conjunction with the exorbitantly-sized, reverse magnetic effect-boosting reverse magnetic stator system (24), improved performance can be achieved. Further, as mentioned, often the results achieved are accomplished empirically. They are nonintuitive as compared to prior understandings of the reverse-winding class of induction motors.

Setting values to approach joule effect breakdown current density levels of current within the reverse stator winding (14) is a completely new understanding for reverse winding motors. The joule effect breakdown current density is a level for each type and size of conductor that is the point at which normal joule effect heating (12R) breaks down because the conductor starts to fail in its given conditions and environment. For the reverse-winding class of induction motors, it as now been determined that it is imperative to avoid getting too close to the joule effect breakdown current density or too much heat may be generated. Obviously, this can depend on the conditions of the motor (altitude, etc.) and the type of case employed, but now by not only exceeding previously perceived limits but by establishing a substantially maximum current density reverse magnetic stator system or a nearly joule effect breakdown current density reverse magnetic stator system (13), improved performance is possible. And previously perceived limitation values are now understood to be sub-optimal as likely far too below the nearly joule effect breakdown current density that is now understood as desirable. Thus, embodiments can have at least one nearly joule effect breakdown current density reverse magnetic stator system (26) and even at least one nearly joule effect breakdown capacitance (27). By powering the at least one nearly joule effect breakdown current density reverse magnetic stator system (26) and rotating the rotor (2) with interaction of the at least one drive stator (3) and the at least one nearly joule effect breakdown current density reverse magnetic stator system (26), improvement can be achieved. To establish at least one nearly joule effect breakdown current density reverse magnetic stator system (26), the at least one nearly joule effect breakdown capacitance (27), or at least one nearly joule effect breakdown capacitance, motors can have a capacitance value selected from about 99%, 98%, 95%, 90%, 85%, and even 80% of a value that effects a joule effect breakdown current density in the reverse stator winding (14). This can be considered as presenting the at least one nearly joule effect breakdown current density reverse magnetic stator system (26).

Finally, capacitance values for some representative motors are presented as just some examples of the types of capacitances that may represent the reverse stator capacitance (15) for some embodiments described herein are shown in Tables 1 and 2. These may be starting points for the empirical effort to find an optimum value. And as to these, it should be understood that these are estimates for some configurations derived from the stator coordinated approach or model to determine capacitor values.

While the inventions have been described in connection with some preferred embodiments, it is not intended to limit the scope of the inventions to the particular form set forth, but on the contrary, it is intended to cover such alternatives, modifications, and equivalents as may be included within the spirit and scope of the inventions as defined by the disclosed embodiments. Examples of alternative claims (posed as clauses) may include:

1. An improved reverse magnetic asynchronous induction motor system comprising:
at least one drive stator;
at least one reverse magnetic stator system;
at least one reverse stator capacitance having a size determined at least in part by the nameplate power and at least in part by the inverse cube of the nameplate voltage of a comparable supplied power but disparate motor type induction motor; and
a rotor.

2. An improved reverse magnetic asynchronous induction motor system as described in clause 1 or any other clause, wherein said at least one reverse stator capacitance comprises at least one reverse stator capacitance having a size determined by parameters for said comparable supplied power but disparate motor type induction motor that are inapplicable to said improved reverse magnetic asynchronous induction motor improved reverse magnetic asynchronous induction motor.

3. An improved reverse magnetic asynchronous induction motor system as described in clause 1 or any other clause, wherein said at least one reverse stator capacitance comprises at least one reverse stator capacitance having a size determined by nameplate parameters of said disparate motor type induction motor.

4. An improved reverse magnetic asynchronous induction motor system as described in clause 1 or any other clause, wherein said at least one reverse magnetic stator system comprises at least one substantially drive stator magnetically coincident reverse stator winding.

5. An improved reverse magnetic asynchronous induction motor system as described in clause 4 or any other clause, wherein said at least one substantially drive stator magnetically coincident reverse stator winding comprises at least one magnetically contravening reverse stator winding.

6. An improved reverse magnetic asynchronous induction motor system as described in clause 5 or any other clause, wherein said drive stator has at least one drive stator winding, and wherein said at least one magnetically contravening reverse stator winding comprises at least one drive stator opposite winding.

7. An improved reverse magnetic asynchronous induction motor system as described in clause 6 or any other clause, wherein said at least one reverse stator capacitance has a size determined at least in part by the inverse of a quantity equal to the nameplate efficiency times the nameplate power factor of said disparate motor type induction motor.

8. An improved reverse magnetic asynchronous induction motor system as described in clause 7 or any other clause, wherein said at least one reverse stator capacitance has a size determined at least in part by a multiplier times said a value determined by said nameplate parameters of said disparate motor type induction motor.

9. An improved reverse magnetic asynchronous induction motor system as described in clause 8 or any other clause, wherein said multiplier comprises a voltage variable multiplier.

10. An improved reverse magnetic asynchronous induction motor system as described in clause 9 or any other clause, wherein said voltage variable multiplier comprises a stepped variable multiplier.

11. An improved reverse magnetic asynchronous induction motor system as described in clause 1 or any other clause, wherein said at least one reverse stator capacitance comprises at least one reverse stator capacitance having a microfarad value substantially equal to a stepped variable multiplier stepping over a specific nameplate voltage range, times the frame's standard nameplate motor power in watts, times the inverse of a quantity equal to: the frame's standard nameplate motor voltage cubed, times the frame's standard nameplate motor efficiency as a decimal value, times the frame's standard nameplate motor power factor as a decimal value.

12. An improved reverse magnetic asynchronous induction motor system as described in clause 11 or any other clause, wherein said stepped variable multiplier comprises an about one hundred eighty-three thousand lower step multiplier value.

13. An improved reverse magnetic asynchronous induction motor system as described in clause 12 or any other clause, wherein said stepped variable multiplier comprises an about one million three hundred fifty-eight thousand upper step multiplier value.

14. An improved reverse magnetic asynchronous induction motor system as described in clause 13 or any other clause, wherein said stepped variable multiplier comprises a limited voltage range ramping variable multiplier comprising an about nine hundred volt lower ramp range value.

15. An improved reverse magnetic asynchronous induction motor system as described in clause 14 or any other clause, wherein said limited voltage range ramping variable multiplier comprises an about twenty-three hundred volt upper ramp range value.

16. An improved reverse magnetic asynchronous induction motor system as described in clause 6 or any other clause, wherein said at least one reverse magnetic stator system comprises at least one rated-full load slip-minimized reverse magnetic stator system.

17. An improved reverse magnetic asynchronous induction motor system as described in clause 6 or any other clause, wherein said at least one reverse stator capacitance comprises at least one exorbitantly-sized reverse magnetic effect-boosting capacitance.

18. An improved reverse magnetic asynchronous induction motor system as described in clause 6 or any other clause, wherein said at least one high total motor-efficiency reverse magnetic stator system comprises at least one drive stator-coordinated reverse magnetic stator system.

19. An improved reverse magnetic asynchronous induction motor system as described in clause 1 or any other clause, wherein said at least one drive stator has a drive stator wire cross-sectional area, wherein said at least one reverse magnetic stator system has a reverse stator winding wire cross-sectional area, and wherein said stator winding wire cross-sectional area to reverse stator winding wire cross-sectional area establishes a ratio of about two.

20. An improved reverse magnetic asynchronous induction motor system as described in clause 1 or any other clause, wherein said at least one reverse magnetic stator system comprises at least one nearly joule effect breakdown current density reverse magnetic stator system.

21. An improved reverse magnetic asynchronous induction motor system as described in clause 1 or any other clause, wherein said improved reverse magnetic asynchronous induction motor system has a motor frame having a comparable motor standard nameplate efficiency value at a rated full load when said motor frame is used without said reverse magnetic stator system in said comparable motor, and wherein said improved reverse magnetic asynchronous induction motor system has constant power efficiency at its rated full load that improves upon said comparable motor standard nameplate efficiency value by an efficiency improvement selected from:
at least a 33% efficiency improvement over said comparable motor standard nameplate efficiency towards 100%;
at least a 40% efficiency improvement over said comparable motor standard nameplate efficiency towards 100%; and
at least a 50% efficiency improvement over said comparable motor standard nameplate efficiency towards 100%.

22. An improved reverse magnetic asynchronous induction motor system as described in clause 1 or any other clause, wherein said improved reverse magnetic asynchronous induction motor system has a motor frame having a comparable motor standard nameplate power factor value at a rated full load when said motor frame is used without said reverse magnetic stator system in said comparable motor, and wherein said improved reverse magnetic asynchronous induction motor system has constant power power factor at its rated full load that improves upon said comparable motor standard nameplate power factor value by a power factor improvement selected from:
at least a 20% power factor improvement over said comparable motor standard nameplate power factor towards 1.0 power factor;
at least a 33% power factor improvement over said comparable motor standard nameplate power factor towards 1.0 power factor;
at least a 40% power factor improvement over said comparable motor standard nameplate power factor towards 1.0 power factor;
at least a 50% power factor improvement over said comparable motor standard nameplate power factor towards 1.0 power factor; and
a power factor improvement over said comparable motor standard nameplate power factor to achieve 1.0 power factor.

23. An improved reverse magnetic asynchronous induction motor system as described in clause 1 or any other clause, wherein said improved reverse magnetic asynchronous induction motor system has a motor frame having a comparable motor standard nameplate slip value at a rated full load when said motor system motor frame is used without said reverse magnetic stator system in said comparable motor, and wherein said improved reverse magnetic asynchronous induction motor system has constant power slip at its rated full load that improves upon said comparable motor standard nameplate slip value by a slip improvement selected from:
at least a 20% slip improvement over said comparable motor standard nameplate slip value towards zero slip;
at least a 50% slip improvement over said comparable motor standard nameplate slip value towards zero slip;
at least a 75% slip improvement over said comparable motor standard nameplate slip value towards zero slip;
at least a 90% slip improvement over said comparable motor standard nameplate slip value towards zero slip; and
at least a 95% slip improvement over said comparable motor standard nameplate slip value towards zero slip.

24. An improved reverse magnetic asynchronous induction motor system as described in clause 6 or any other clause, wherein said improved reverse magnetic asynchronous induction motor system comprises at least one at least IE4-total motor-efficiency reverse magnetic stator system.

25. An improved reverse magnetic asynchronous induction motor system as described in clause 6 or any other clause, wherein said improved reverse magnetic asynchronous induction motor system comprises at least one at least NEMA super premium total motor-efficiency reverse magnetic stator system.

26. An improved reverse magnetic asynchronous induction motor system comprising:
at least one drive stator,
at least one reverse magnetic stator system;
at least one reverse stator capacitance having a size determined by a comparable supplied power but disparate motor type induction motor; and
a rotor.

27. An improved reverse magnetic asynchronous induction motor system as described in clause 26 or any other clause, wherein said at least one reverse stator capacitance comprises at least one reverse stator capacitance having a size determined by parameters for said comparable supplied power but disparate motor type induction motor that are inapplicable to said improved reverse magnetic asynchronous induction motor improved reverse magnetic asynchronous induction motor.

28. An improved reverse magnetic asynchronous induction motor system as described in clause 27 or any other clause, wherein said at least one reverse stator capacitance comprises at least one reverse stator capacitance having a size determined by nameplate parameters of said disparate motor type induction motor.

29. An improved reverse magnetic asynchronous induction motor system as described in clause 28 or any other clause, wherein said at least one reverse stator capacitance has a size determined at least in part by the inverse cube of the nameplate voltage of said disparate motor type induction motor.

30. An improved reverse magnetic asynchronous induction motor system as described in clause 28 or any other clause, wherein said at least one reverse stator capacitance has a size determined at least in part by the nameplate power of said disparate motor type induction motor.

31. An improved reverse magnetic asynchronous induction motor system as described in clause 30 or any other clause, wherein said at least one reverse stator capacitance has a size determined at least in part by the inverse of a quantity equal to the nameplate efficiency times the nameplate power factor of said disparate motor type induction motor.

32. An improved reverse magnetic asynchronous induction motor system as described in clause 28 or any other clause, wherein said at least one reverse stator capacitance has a size determined at least in part by a multiplier times said a value determined by said nameplate parameters of said disparate motor type induction motor.

33. An improved reverse magnetic asynchronous induction motor system as described in clause 32 or any other clause, wherein said at least a one and sixty-five hundredths multiplier comprises an at least a one and sixty-five hundredths voltage variable multiplier.

34. An improved reverse magnetic asynchronous induction motor system as described in clause 33 or any other clause, wherein said at least a one and sixty-five hundredths voltage variable multiplier comprises a stepped variable multiplier.

35. An improved reverse magnetic asynchronous induction motor system as described in clause 34 or any other clause, wherein said stepped variable multiplier comprises an about one hundred eighty-three thousand lower step multiplier value.

36. An improved reverse magnetic asynchronous induction motor system as described in clause 35 or any other clause, wherein said stepped variable multiplier comprises an about one million three hundred fifty-eight thousand upper step multiplier value.

37. An improved reverse magnetic asynchronous induction motor system as described in clause 34 or any other clause, wherein said stepped variable multiplier comprises a supply voltage range variable multiplier.

38. An improved reverse magnetic asynchronous induction motor system as described in clause 37 or any other clause, wherein said supply voltage range variable multiplier comprises a supply voltage range ramped up variable multiplier.

39. An improved reverse magnetic asynchronous induction motor system as described in clause 38 or any other clause, wherein said supply voltage range ramped up variable multiplier comprises a limited voltage range ramping variable multiplier.

40. An improved reverse magnetic asynchronous induction motor system as described in clause 39 or any other clause, wherein said limited voltage range ramping variable multiplier comprises an about nine hundred volt lower ramp range value.

41. An improved reverse magnetic asynchronous induction motor system as described in clause 40 or any other clause, wherein said limited voltage range ramping variable multiplier comprises an about twenty-three hundred volt upper ramp range value.

42. An improved reverse magnetic asynchronous induction motor system as described in clause 34 or any other clause, wherein said stepped variable multiplier comprises a linearly varying stepped multiplier.

43. An improved reverse magnetic asynchronous induction motor system as described in clause 34 or any other clause, wherein said stepped variable multiplier comprises a smoothed step multiplier.

44. An improved reverse magnetic asynchronous induction motor system as described in clause 39 or any other clause, wherein said limited voltage range ramping variable multiplier comprises a linear voltage range ramping variable multiplier.

45. An improved reverse magnetic asynchronous induction motor system as described in clause 39 or any other clause, wherein said limited voltage range ramping variable multiplier comprises a smoothed range ramping variable multiplier.

46. An improved reverse magnetic asynchronous induction motor system as described in clause 45 or any other clause, wherein said smoothed range ramping variable multiplier comprises a ramp centered on about a 1550V value.

47. An improved reverse magnetic asynchronous induction motor system as described in clause 34 or any other clause, wherein said at least one drive stator has a drive stator wire cross-sectional area, wherein said at least one reverse magnetic stator system has a reverse stator winding wire cross-sectional area, and wherein said stator winding wire cross-sectional area to reverse stator winding wire cross-sectional area establishes a ratio of about two.

48. An improved reverse magnetic asynchronous induction motor system comprising:
at least one drive stator;
at least one drive stator-coordinated reverse magnetic stator system;
a rotor; and
a motor frame encasing at least said at least one drive stator and said rotor.

49. An improved reverse magnetic asynchronous induction motor system as described in clause 48 or any other clause, wherein said at least one drive stator-coordinated reverse magnetic stator system comprises at least one drive stator-coordinated capacitance.

50. An improved reverse magnetic asynchronous induction motor system as described in clause 49 or any other clause, wherein said reverse magnetic stator system comprises at least one reverse stator winding.

51. An improved reverse magnetic asynchronous induction motor system as described in clause 50 or any other clause, wherein said at least one reverse stator winding comprises at least one substantially drive stator magnetically coincident reverse stator winding.

52. An improved reverse magnetic asynchronous induction motor system as described in clause 51 or any other clause, wherein said at least one reverse stator winding comprises at least one substantially drive stator magnetically coincident reverse stator winding.

53. An improved reverse magnetic asynchronous induction motor system as described in clause 52 or any other clause, wherein said at least one substantially drive stator magnetically coincident reverse stator winding comprises at least one magnetically contravening reverse stator winding.

54. An improved reverse magnetic asynchronous induction motor system comprising:
at least one drive stator;
at least one nearly joule effect breakdown current density reverse magnetic stator system;
and
a rotor.

55. An improved reverse magnetic asynchronous induction motor system as described in clause 51 or any other clause, wherein said at least one nearly joule effect breakdown current density reverse magnetic stator system comprises at least one nearly joule effect breakdown capacitance.

56. An improved reverse magnetic asynchronous induction motor system as described in clause 55 or any other clause, wherein said at least one nearly joule effect breakdown current density reverse magnetic stator system comprises at least one reverse stator winding, and wherein said at least one nearly joule effect breakdown capacitance comprises a capacitor having a capacitance value selected from:
a capacitance value that is about 99% of a value that effects a joule effect breakdown current density in said reverse winding;
a capacitance value that is about 98% of a value that effects a joule effect breakdown current density in said reverse winding;
a capacitance value that is about 95% of a value that effects a joule effect breakdown current density in said reverse winding;
a capacitance value that is about 90% of a value that effects a joule effect breakdown current density in said reverse winding;
a capacitance value that is about 85% of a value that effects a joule effect breakdown current density in said reverse winding; and
a capacitance value that is about 80% of a value that effects a joule effect breakdown current density in said reverse winding.

57. An improved reverse magnetic asynchronous induction motor system as described in clause 56 or any other clause, wherein said at least one drive stator has a drive stator wire cross-sectional area, wherein said at least one reverse magnetic stator system has a reverse stator winding wire cross-sectional area, and wherein said stator winding wire cross-sectional area to reverse stator winding wire cross-sectional area establishes a ratio of about two.

58. An improved reverse magnetic asynchronous induction motor system as described in clause 54 or any other clause, wherein said reverse magnetic stator system comprises at least one drive stator-coordinated reverse magnetic stator system.

59. An improved reverse magnetic asynchronous induction motor system as described in clause 54 or any other clause, wherein said at least one capacitor comprises at least one reverse stator capacitance having a size determined by a comparable supplied power but disparate motor type induction motor.

60. An improved reverse magnetic asynchronous induction motor system comprising:
at least one drive stator having at least one drive stator reactance;
at least one reverse magnetic stator system;
at least one exorbitantly-sized reverse magnetic effect-boosting capacitance;
a rotor; and
a motor frame.

61. An improved reverse magnetic asynchronous induction motor system as described in clause 60 or any other clause, wherein said at least one reverse magnetic stator system comprises a reverse winding, and wherein said at least one reverse magnetic stator system comprises at least one exorbitantly-sized, reverse magnetic effect-boosting reverse magnetic stator system.

62. An improved reverse magnetic asynchronous induction motor system as described in clause 61 or any other clause, wherein said at least one reverse magnetic stator system comprises at least one nearly joule effect breakdown current density reverse magnetic stator system.

63. An improved reverse magnetic asynchronous induction motor system as described in clause 62 or any other clause, wherein said at least one drive stator has a drive stator wire cross-sectional area, wherein said at least one reverse magnetic stator system has a reverse stator winding wire cross-sectional area, and wherein said stator winding wire cross-sectional area to reverse stator winding wire cross-sectional area establishes a ratio of about two.

64. An improved reverse magnetic asynchronous induction motor system as described in clause 60 or any other clause, wherein said reverse magnetic stator system comprises at least one drive stator-coordinated reverse magnetic stator system.

65. An improved reverse magnetic asynchronous induction motor system as described in clause 60 or any other clause, wherein said at least one capacitor comprises at least one reverse stator capacitance having a size determined by a comparable supplied power but disparate motor type induction motor.

66. An improved reverse magnetic asynchronous induction motor system comprising:
at least one drive stator;
at least one rated-full load slip-minimized reverse magnetic stator system; and
a rotor.

67. An improved reverse magnetic asynchronous induction motor system as described in clause 66 or any other clause, wherein said at least one rated-full load slip-minimized reverse magnetic stator system comprises at least one slip-minimized capacitance.

68. An improved reverse magnetic asynchronous induction motor system as described in clause 66 or any other clause, wherein said motor system has a motor frame having a comparable motor standard nameplate slip value at a rated full load when said motor frame is used without said reverse magnetic stator system in said comparable motor, and wherein said improved reverse magnetic asynchronous induction motor system has slip at its rated full load that improves upon said comparable motor standard nameplate slip value by at least a 20% slip improvement over that amount towards zero slip.

69. An improved reverse magnetic asynchronous induction motor system as described in clause 66 or any other clause, wherein said reverse magnetic stator system comprises at least one drive stator-coordinated reverse magnetic stator system.

70. An improved reverse magnetic asynchronous induction motor system as described in clause 66 or any other clause, wherein said at least one capacitor comprises at least one reverse stator capacitance having a size determined by a comparable supplied power but disparate motor type induction motor.

71. An improved reverse magnetic asynchronous induction motor system comprising:
at least one drive stator;
at least one at least IE4-total motor-efficiency reverse magnetic stator system;
a rotor;
an induction motor system drive system; and
a motor frame.

72. An improved reverse magnetic asynchronous induction motor system comprising:
at least one drive stator;
at least one at least NEMA super premium total motor-efficiency reverse magnetic stator system;
a rotor;
an induction motor system drive system; and
a motor frame.

73. An improved reverse magnetic asynchronous induction motor system comprising:
at least one drive stator;
at least one high total motor-efficiency reverse magnetic stator system;
a rotor;
an induction motor system drive system; and
a motor frame.

74. An improved reverse magnetic asynchronous induction motor system as described in clause 73 or any other clause, wherein said at least one high total motor-efficiency reverse magnetic stator system comprises at least one at least IE4-total motor-efficiency reverse magnetic stator system.

75. An improved reverse magnetic asynchronous induction motor system as described in clause 73 or any other clause, wherein said at least one high total motor-efficiency reverse magnetic stator system comprises at least one at least NEMA super premium total motor-efficiency reverse magnetic stator system.

76. An improved reverse magnetic asynchronous induction motor system as described in clause 71 or any other clause, wherein said at least one at least IE4-total motor-efficiency reverse magnetic stator system comprises at least IE4-total motor-efficiency capacitance.

77. An improved reverse magnetic asynchronous induction motor system as described in clause 71 or any other clause, wherein said motor system has a motor frame having a comparable motor standard nameplate efficiency value at a rated full load when said motor system motor frame is used without said reverse magnetic stator system in said comparable motor, and wherein said improved reverse magnetic asynchronous induction motor system has constant power efficiency at its rated full load that improves upon said comparable motor standard nameplate efficiency value by at least a 20% efficiency improvement over that amount towards 100% efficiency.

78. An improved reverse magnetic asynchronous induction motor system as described in clause 71 or any other clause, wherein said improved reverse magnetic asynchronous induction motor system has a motor frame having a comparable motor standard nameplate efficiency value at a rated full load when said motor system motor frame is used without said reverse magnetic stator system in said comparable motor, and wherein said improved reverse magnetic asynchronous induction motor system has constant power efficiency at its rated full load that improves upon said comparable motor standard nameplate efficiency value by an efficiency improvement selected from:
at least a 20% efficiency improvement over said comparable motor standard nameplate efficiency towards 100%;
at least a 33% efficiency improvement over said comparable motor standard nameplate efficiency towards 100%;
at least a 40% efficiency improvement over said comparable motor standard nameplate efficiency towards 100%; and
at least a 50% efficiency improvement over said comparable motor standard nameplate efficiency towards 100%.

79. An improved reverse magnetic asynchronous induction motor system as described in clause 78 or any other clause, wherein said improved reverse magnetic asynchronous induction motor system has a motor frame having a comparable motor standard nameplate power factor value at a rated full load when said motor system motor frame is used without said reverse magnetic stator system in said comparable motor, and wherein said improved reverse magnetic asynchronous induction motor system has constant power power factor at its rated full load that improves upon said comparable motor standard nameplate power factor value by a power factor improvement selected from:
at least a 20% power factor improvement over said comparable motor standard nameplate power factor towards 1.0 power factor;
at least a 50% power factor improvement over said comparable motor standard nameplate power factor towards 1.0 power factor;
at least a 75% power factor improvement over said comparable motor standard nameplate power factor towards 1.0 power factor;
at least a 90% power factor improvement over said comparable motor standard nameplate power factor towards 1.0 power factor; and
a power factor improvement over said comparable motor standard nameplate power factor to achieve 1.0 power factor.

80. An improved reverse magnetic asynchronous induction motor system as described in clause 78 or any other clause, wherein said improved reverse magnetic asynchronous induction motor system has a motor frame having a comparable motor standard nameplate slip value at a rated full load when said motor system motor frame is used without said reverse magnetic stator system in said comparable motor, and wherein said improved reverse magnetic asynchronous induction motor system has constant power slip at its rated full load that improves upon said comparable motor standard nameplate slip value by a slip improvement selected from:
at least a 20% slip improvement over said comparable motor standard nameplate slip value towards zero slip;
at least a 50% slip improvement over said comparable motor standard nameplate slip value towards zero slip;
at least a 75% slip improvement over said comparable motor standard nameplate slip value towards zero slip;
at least a 90% slip improvement over said comparable motor standard nameplate slip value towards zero slip; and
at least a 95% slip improvement over said comparable motor standard nameplate slip value towards zero slip.

81. An improved reverse magnetic asynchronous induction motor system as described in clause 71 or any other clause, wherein said IE4-total motor-efficiency comprises substantially constant power efficiency.

82. An improved reverse magnetic asynchronous induction motor system as described in clause 71 or any other clause, wherein said reverse magnetic stator system comprises at least one drive stator-coordinated reverse magnetic stator system.

83. An improved reverse magnetic asynchronous induction motor system as described in clause 71 or any other clause, wherein said at least one capacitor comprises at least one reverse stator capacitance having a size determined by a comparable supplied power but disparate motor type induction motor.

84. An improved reverse magnetic asynchronous induction motor system as described in clause 48, 54, 61, 66, 71, or any other clause, wherein said reverse magnetic stator system comprises at least one reverse stator winding.

85. An improved reverse magnetic asynchronous induction motor system as described in clause 84 or any other clause, wherein said at least one reverse stator winding comprises at least one substantially drive stator magnetically coincident reverse stator winding.

86. An improved reverse magnetic asynchronous induction motor system as described in clause 85 or any other clause, wherein said at least one substantially drive stator magnetically coincident reverse stator winding comprises at least one magnetically contravening reverse stator winding.

87. An improved reverse magnetic asynchronous induction motor system as described in clause 86 or any other clause, wherein said drive stator has at least one drive stator winding, and wherein said at least one magnetically contravening reverse stator winding comprises at least one drive stator opposite winding.

88. An improved reverse magnetic asynchronous induction motor system as described in clause 19, 55, 60, 67, 76 or any other clause, wherein said at least one capacitor comprises at least one reverse stator capacitance having a size determined by a comparable supplied power but disparate motor type induction motor.

89. An improved reverse magnetic asynchronous induction motor system as described in clause 88 or any other clause, wherein said at least one reverse stator capacitance having a size determined at least in part by a comparable supplied power but disparate motor type induction motor comprises at least one reverse stator capacitance having a size determined by parameters for said comparable supplied power but disparate motor type induction motor that are inapplicable to said improved reverse magnetic asynchronous induction motor improved reverse magnetic asynchronous induction motor.

90. An improved reverse magnetic asynchronous induction motor system as described in clause 88 or any other clause, wherein said at least one reverse stator capacitance having a size determined by a comparable supplied power but disparate motor type induction motor comprises at least one reverse stator capacitance having a size determined by nameplate parameters of said disparate motor type induction motor.

91. An improved reverse magnetic asynchronous induction motor system as described in clause 90 or any other clause, wherein said at least one reverse stator capacitance has a size determined at least in part by the nameplate voltage of said disparate motor type induction motor.

92. An improved reverse magnetic asynchronous induction motor system as described in clause 91 or any other clause, wherein said at least one reverse stator capacitance has a size determined at least in part by the inverse cube of the nameplate voltage of said disparate motor type induction motor.

93. An improved reverse magnetic asynchronous induction motor system as described in clause 90 or any other clause, wherein said at least one reverse stator capacitance has a size determined at least in part by the nameplate power of said disparate motor type induction motor.

94. An improved reverse magnetic asynchronous induction motor system as described in clause 93 or any other clause, wherein said at least one reverse stator capacitance has a size determined at least in part by the nameplate efficiency and power factor of said disparate motor type induction motor.

95. An improved reverse magnetic asynchronous induction motor system as described in clause 94 or any other clause, wherein said at least one reverse stator capacitance has a size determined at least in part by the inverse of a quantity equal to the nameplate efficiency times the nameplate power factor of said disparate motor type induction motor.

96. An improved reverse magnetic asynchronous induction motor system as described in clause 90 or any other clause, wherein said at least one reverse stator capacitance has a size determined at least in part by a multiplier times said a value determined by said nameplate parameters of said disparate motor type induction motor.

97. An improved reverse magnetic asynchronous induction motor system as described in clause 96 or any other clause, wherein said multiplier comprises a voltage variable multiplier.

98. An improved reverse magnetic asynchronous induction motor system as described in clause 97 or any other clause, wherein said voltage variable multiplier comprises a stepped variable multiplier.

99. An improved reverse magnetic asynchronous induction motor system as described in clause 98 or any other clause, wherein said stepped variable multiplier comprises an about one hundred eighty-three thousand lower step multiplier value.

100. An improved reverse magnetic asynchronous induction motor system as described in clause 99 or any other clause, wherein said stepped variable multiplier comprises an about one million three hundred fifty-eight thousand upper step multiplier value.

101. An improved reverse magnetic asynchronous induction motor system as described in clause 98 or any other clause, wherein said stepped variable multiplier comprises a supply voltage range variable multiplier.

102. An improved reverse magnetic asynchronous induction motor system as described in clause 101 or any other clause, wherein said supply voltage range variable multiplier comprises a supply voltage range ramped up variable multiplier.

103. An improved reverse magnetic asynchronous induction motor system as described in clause 102 or any other clause, wherein said supply voltage range ramped up variable multiplier comprises a limited voltage range ramping variable multiplier.

104. An improved reverse magnetic asynchronous induction motor system as described in clause 103 or any other clause, wherein said limited voltage range ramping variable multiplier comprises an about nine hundred volt lower ramp range value.

105. An improved reverse magnetic asynchronous induction motor system as described in clause 104 or any other clause, wherein said limited voltage range ramping variable multiplier comprises an about twenty-three hundred volt upper ramp range value.

106. An improved reverse magnetic asynchronous induction motor system as described in clause 98 or any other clause, wherein said stepped variable multiplier comprises a linearly varying stepped multiplier.

107. An improved reverse magnetic asynchronous induction motor system as described in clause 98 or any other clause, wherein said stepped variable multiplier comprises a smoothed step multiplier.

108. An improved reverse magnetic asynchronous induction motor system as described in clause 103 or any other clause, wherein said limited voltage range ramping variable multiplier comprises a linear voltage range ramping variable multiplier.

109. An improved reverse magnetic asynchronous induction motor system as described in clause 103 or any other clause, wherein said limited voltage range ramping variable multiplier comprises a smoothed range ramping variable multiplier.

110. An improved reverse magnetic asynchronous induction motor system as described in clause 109 or any other clause, wherein said smoothed range ramping variable multiplier comprises a ramp centered on about a 1550V value.

111. An improved reverse magnetic asynchronous induction motor system as described in clause 98 or any other clause, wherein said at least one drive stator has a drive stator wire cross-sectional area, wherein said at least one reverse magnetic stator system has a reverse stator winding wire cross-sectional area, and wherein said stator winding wire cross-sectional area to reverse stator winding wire cross-sectional area establishes a ratio of about two.

112. An improved reverse magnetic asynchronous induction motor system as described in clause 48, 54, 61, 66, 71, or any other clause, wherein said at least one drive stator has a drive stator wire cross-sectional area, wherein said at least one reverse magnetic stator system has a reverse stator winding wire cross-sectional area, and wherein said drive stator winding wire cross-sectional area to reverse stator winding wire cross-sectional area establishes a ratio of about two.

113. An improved reverse magnetic asynchronous induction motor system as described in clause 48, 54, 61, 66, 71, or any other clause and further comprising at least one exorbitantly-sized reverse magnetic effect-boosting capacitance.

114. An improved reverse magnetic asynchronous induction motor system as described in clause 48, 54, 61, 66, 71, or any other clause, wherein said at least one reverse magnetic stator system comprises at least one nearly joule effect breakdown current density reverse magnetic stator system.

115. An improved reverse magnetic asynchronous induction motor system as described in clause 114 or any other clause, wherein said at least one nearly joule effect breakdown current density reverse magnetic stator system comprises at least one nearly joule effect breakdown capacitance.

116. An improved reverse magnetic asynchronous induction motor system as described in clause 115 or any other clause, wherein said at least one nearly joule effect breakdown current density reverse magnetic stator system comprises at least one reverse stator winding, and wherein said at least one nearly joule effect breakdown capacitance comprises a capacitor having a capacitance value selected from:
a capacitance value that is about 99% of a value that effects a joule effect breakdown current density in said reverse winding;
a capacitance value that is about 98% of a value that effects a joule effect breakdown current density in said reverse winding;
a capacitance value that is about 95% of a value that effects a joule effect breakdown current density in said reverse winding;
a capacitance value that is about 90% of a value that effects a joule effect breakdown current density in said reverse winding;
a capacitance value that is about 85% of a value that effects a joule effect breakdown current density in said reverse winding; and
a capacitance value that is about 80% of a value that effects a joule effect breakdown current density in said reverse winding.

117. An improved reverse magnetic asynchronous induction motor system as described in clause 116 or any other clause, wherein said at least one drive stator has a drive stator wire cross-sectional area, wherein said at least one reverse magnetic stator system has a reverse stator winding wire cross-sectional area, and wherein said stator winding wire cross-sectional area to reverse stator winding wire cross-sectional area establishes a ratio of about two.

118. An improved reverse magnetic asynchronous induction motor system as described in clause 48, 54, 61, 66, 71, or any other clause, wherein said at least one reverse magnetic stator system comprises at least one efficiency optimizing reverse magnetic stator system.

119. An improved reverse magnetic asynchronous induction motor system as described in clause 48, 54, 61, 66, 71 or any other clause, wherein said at least one efficiency optimizing reverse magnetic stator system comprises an at least IE4-total motor-efficiency reverse magnetic stator system.

120. An improved reverse magnetic asynchronous induction motor system as described in clause 48, 54, 61, 66, 71, or any other clause, wherein said motor system has a total motor efficiency at constant power, at 100% of its rated load, and wherein said total motor efficiency comprises a total motor efficiency selected from:
at least 98.5% efficiency for motors having rated full loads above 2 megawatts;
at least 99% efficiency for motors having rated full loads above 2 megawatts;
at least 98.5% efficiency for motors having rated full loads from 1 megawatt to 2 megawatts;
at least 99% efficiency for motors having rated full loads from 1 megawatt to 2 megawatts;
at least 98% efficiency for motors having rated full loads from 500 kilowatts to 1000 kilowatts;
at least 98.5% efficiency for motors having rated full loads from 500 kilowatts to 1000 kilowatts;
at least 97.5% efficiency for motors having rated full loads from 100 kilowatts to 500 kilowatts;
at least 98% efficiency for motors having rated full loads from 100 kilowatts to 500 kilowatts;
at least 97% efficiency for motors having rated full loads from 20 kilowatts to 100 kilowatts;
at least 97.5% efficiency for motors having rated full loads from 20 kilowatts to 100 kilowatts;
at least 96.5% efficiency for motors having rated full loads from 5 kilowatts to 20 kilowatts;
at least 97% efficiency for motors having rated full loads from 5 kilowatts to 20 kilowatts;
at least 96% efficiency for motors having rated full loads from 1 kilowatts to 5 kilowatts; and
at least 96.5% efficiency for motors having rated full loads from 1 kilowatts to 5 kilowatts.

121. An improved reverse magnetic asynchronous induction motor system as described in clause 48, 54, 61, 66, 71, or any other clause, wherein said improved reverse magnetic asynchronous induction motor system has efficiency characteristics that represent a reduction from perfect efficiency that exceeds a specific current IEC/EN 60034-30-1:2014 IE4 efficiency standard for that motor type when said motor system motor frame is used without said reverse magnetic stator system in a comparable motor by an improvement toward perfect efficiency selected from:
at least a 20% efficiency improvement toward perfect efficiency as compared to said IEC/EN 60034-30-1:2014 IE4 efficiency standard for said comparable motor;
at least a 33% efficiency improvement toward perfect efficiency as compared to said IEC/EN 60034-30-1:2014 IE4 efficiency standard for said comparable motor;
at least a 40% efficiency improvement toward perfect efficiency as compared to said IEC/EN 60034-30-1:2014 IE4 efficiency standard for said comparable motor; and
at least a 50% efficiency improvement toward perfect efficiency as compared to said IEC/EN 60034-30-1:2014 IE4 efficiency standard for said comparable motor.

122. An improved reverse magnetic asynchronous induction motor system as described in clause 48, 54, 61, 66, 71, or any other clause, wherein said improved reverse magnetic asynchronous induction motor system has a motor frame having a comparable motor standard nameplate efficiency value at a rated full load for that motor type when said motor system motor frame is used without said reverse magnetic stator system in said comparable motor, and wherein said improved reverse magnetic asynchronous induction motor system has constant power efficiency at its rated full load that improves upon said comparable motor standard nameplate efficiency value by an efficiency improvement selected from:
at least a 20% efficiency improvement over said comparable motor standard nameplate efficiency towards 100%;
at least a 33% efficiency improvement over said comparable motor standard nameplate efficiency towards 100%;
at least a 40% efficiency improvement over said comparable motor standard nameplate efficiency towards 100%; and
at least a 50% efficiency improvement over said comparable motor standard nameplate efficiency towards 100%.

123. An improved reverse magnetic asynchronous induction motor system as described in clause 48, 54, 61, 66, 71, or any other clause, wherein said improved reverse magnetic asynchronous induction motor system has a motor frame having a comparable motor standard nameplate power factor value at a rated full load when said motor system motor frame is used without said reverse magnetic stator system in said comparable motor, and wherein said improved reverse magnetic asynchronous induction motor system has constant power power factor at its rated full load that improves upon said comparable motor standard nameplate power factor value by a power factor improvement selected from:
at least a 20% power factor improvement over said comparable motor standard nameplate power factor towards 1.0 power factor;
at least a 50% power factor improvement over said comparable motor standard nameplate power factor towards 1.0 power factor;
at least a 75% power factor improvement over said comparable motor standard nameplate power factor towards 1.0 power factor;
at least a 90% power factor improvement over said comparable motor standard nameplate power factor towards 1.0 power factor; and
a power factor improvement over said comparable motor standard nameplate power factor to achieve 1.0 power factor.

124. An improved reverse magnetic asynchronous induction motor system as described in clause 48, 54, 61, 66, 71, or any other clause, wherein said improved reverse magnetic asynchronous induction motor system has a motor frame having a comparable motor standard nameplate slip value at a rated full load for that motor type when said motor system motor frame is used without said reverse magnetic stator system in said comparable motor, and wherein said improved reverse magnetic asynchronous induction motor system has constant power slip at its rated full load that improves upon said comparable motor standard nameplate slip value by a slip improvement selected from:
at least a 20% slip improvement over said comparable motor standard nameplate slip value towards zero slip;
at least a 50% slip improvement over said comparable motor standard nameplate slip value towards zero slip;
at least a 75% slip improvement over said comparable motor standard nameplate slip value towards zero slip;
at least a 90% slip improvement over said comparable motor standard nameplate slip value towards zero slip; and
at least a 95% slip improvement over said comparable motor standard nameplate slip value towards zero slip.

125. An improved reverse magnetic asynchronous induction motor system as described in clause 48, 54, 61, 66, 71, or any other clause, wherein said motor system has a motor slip at greater than 75% of its rated full load, and wherein said motor system slip comprises a motor slip selected from:
less than 0.5% slip at greater than 75% of its rated full load;
less than 0.3% slip at greater than 75% of its rated full load;
less than 0.1% slip at greater than 75% of its rated full load;
less than 0.5% slip at its rated full load;
less than 0.3% slip at its rated full load; and
less than 0.1% slip at its rated full load.

126. An improved reverse magnetic asynchronous induction motor system as described in clause 125 or any other clause, wherein said motor slip at greater than 75% of its rated full load is up to 0.06% slip.

127. A method of providing power from an asynchronous induction motor system comprising the steps of:
powering at least one drive stator;
powering at least one drive stator-coordinated reverse magnetic stator system; and
rotating a rotor with interaction of said at least one drive stator and said at least one drive stator-coordinated reverse magnetic stator system.

128. A method of providing power from an asynchronous induction motor system comprising the steps of:
providing an induction motor system drive system;
powering at least one drive stator;
powering at least one at least IE4-total motor-efficiency reverse magnetic stator system;
rotating a rotor with interaction of said at least one drive stator and said at least one high efficiency reverse magnetic stator system;
encasing said drive stator, a reverse magnetic stator, and said rotor;
achieving at least IE4-total motor-efficiency by said motor system as compared to said comparable motor.

129. A method of providing power from an asynchronous induction motor system comprising the steps of:
powering at least one drive stator;
powering at least one rated-full load slip-minimized reverse magnetic stator system; and
rotating a rotor with interaction of said at least one drive stator and said at least one rated-full load slip-minimized reverse magnetic stator system.

130. A method of providing power from an asynchronous induction motor system comprising the steps of:
powering at least one drive stator;
powering at least one nearly joule effect breakdown current density reverse magnetic stator system; and
rotating a rotor with interaction of said at least one drive stator and said at least one nearly joule effect breakdown current density reverse magnetic stator system.

131. A method of providing power from an asynchronous induction motor system comprising the steps of:
powering at least one drive stator;
powering at least one reverse magnetic stator;
effecting power to said at least one reverse magnetic stator by at least one exorbitantly-sized reverse magnetic effect-boosting capacitance; and
rotating a rotor with interaction of said at least one drive stator and said at least one reverse magnetic stator.

132. A method of providing power from an asynchronous induction motor system comprising the steps of:
powering at least one drive stator;
powering at least one reverse magnetic stator;
effecting power to said at least one reverse magnetic stator by at least one reverse stator capacitance having a size determined by a comparable supplied power but disparate motor type induction motor; and
rotating a rotor with interaction of said at least one drive stator and said at least one reverse magnetic stator.

As can be easily understood, the basic concepts of the various embodiments of the present inventions may be embodied in a variety of ways. It involves both reverse-winding induction motor power techniques as well as reverse-winding induction motors to accomplish the appropriate powering. In this application, the powering techniques are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this patent is intended to serve as a basic description. The reader should be aware that the specific discussion may not explicitly describe all embodiments possible; many alternatives are implicit. It also may not fully explain the generic nature of the various embodiments of the inventions and may not explicitly show how each feature or element can actually be representative of a broader function or of a great variety of alternative or equivalent elements. As one example, terms of degree, terms of approximation, and/or relative terms may be used. These may include terms such as the words: substantially, about, only, and the like. These words and types of words are to be understood in a dictionary sense as terms that encompass an ample or considerable amount, quantity, size, etc. as well as terms that encompass largely but not wholly that which is specified. Further, for this application if or when used, terms of degree, terms of approximation, and/or relative terms should be understood as also encompassing more precise and even quantitative values that include various levels of precision and the possibility of claims that address a number of quantitative options and alternatives.

Where the application is described in device-oriented terminology, each element of the device implicitly performs a function. Apparatus claims may not only be included and added for the devices described, but also method or process claims may be included to address the functions of the embodiments and that each element performs. Neither the description nor the terminology is intended to limit the scope of the claims that will be included in any subsequent patent.

It should also be understood that a variety of changes may be made without departing from the essence of the various embodiments of the inventions. Such changes are also implicitly included in the description. They still fall within the scope of the various embodiments of the inventions. With this understanding, the reader should be aware that this disclosure is to be understood to support any subsequently filed patent that may seek as broad a base of claims as deemed within the applicant's right and may be designed to yield a patent covering numerous aspects of embodiments of the inventions both independently and as an overall system.

Further, each of the various elements of the embodiments of the inventions and claims may also be achieved in a variety of manners. Additionally, when used or implied, an element is to be understood as encompassing individual as well as plural structures that may or may not be physically connected. This disclosure should be understood to encompass each such variation, be it a variation of an embodiment of any apparatus embodiment, a method or process embodiment, or even merely a variation of any element of these. Particularly, it should be understood that as the disclosure relates to elements of the various embodiments of the inventions, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which embodiments of the inventions is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of a “source of power” should be understood to encompass disclosure of the act of “powering”—whether explicitly discussed or not—and, conversely, were there effectively disclosure of the act of “powering”, such a disclosure should be understood to encompass disclosure of a “source of power” and even a “means for powering” if desired by explicit words (recognizing the legal limits involved therein). Such changes and alternative terms are to be understood to be explicitly included in the description. Further, each such means (when explicitly described by words having such limits) should be understood as encompassing all elements that can perform the given function, and all descriptions of elements that perform a described function should be understood as a non-limiting example of means for performing that function. As other non-limiting examples, it should be understood that claim elements can also be expressed as any of: elements that are configured to, or configured and arranged to, provide or even achieve a particular result, use, purpose, situation, function, or operation, or as components that are capable of achieving a particular activity, result, use, purpose, situation, function, or operation. All should be understood as within the scope of this disclosure and written description.

Any standards, regulations, or rules mentioned in this application for patent, and any patents, publications, or other references mentioned in this patent are hereby incorporated by reference. Any priority case(s) claimed by this application is hereby appended and hereby incorporated by reference. In addition, as to each term used it should be understood that unless its utilization in this application is inconsistent with a broadly supporting interpretation, common dictionary definitions should be understood as incorporated for each term and all definitions, alternative terms, and synonyms such as contained in the Random House Webster's Unabridged Dictionary, second edition are hereby incorporated by reference. Finally, all references listed in any list of References in an Information Disclosure Statement, or lists To Be Incorporated By Reference In Accordance With this Application or other information statement filed with the application are hereby appended and hereby incorporated by reference, however, as to each of the above, to the extent that such information or statements incorporated by reference might be considered inconsistent with the patenting of the various embodiments of inventions such statements are expressly not to be considered as made by the applicant(s) in the context of this disclosure and these inventions.

### REFERENCES TO BE INCORPORATED BY REFERENCE

### I. U.S. Patents

| Patent No. | Kind Code | Date Issued | Patentee |
|---|---|---|---|
| 10,903,770 | B1 | 2021 Jan. 26 | Goche |
| 7,034,426 | B2 | 2006 Apr. 25 | Goche |
| 7,227,288 | B2 | 2007 Jun. 5 | Goche |
| 4,672,298 | A | 1987 Jun. 9 | Rohatyn |
| 5,838,127 | A | 1998 Nov. 17 | Young, et al. |
| 4,446,416 | A | 1984 May 1 | Wanlass |
| 5,212,435 | | 1993 May 18 | Dutro |
| 2,100,660 | | 1937 Nov. 30 | Greiner |
| 4,063,135 | | 1977 Dec. 13 | Wanlass |
| 4,095,149 | | 1978 Jun. 13 | Wanlass |
| 4,132,932 | | 1979 Jan. 2 | Wanlass |
| 4,134,052 | | 1979 Jan. 9 | Wanlass et al. |
| 4,152,630 | | 1979 May 1 | Wanlass |
| 4,187,457 | | 1980 Feb. 5 | Wanlass |
| 4,338,557 | | 1982 Jul. 6 | Wanlass |
| 8,093,857 | B1 | 2012 Jan. 10 | Kolomeitsev |
| 8,773,062 | B2 | 2014 Jul. 8 | Kolomeitsev |
| 9,997,983 | B2 | 2018 Jun. 12 | Nordstrom et al. |
| 3,291,998 | | 1966 Dec. 13 | Wildi |
| 3,707,661 | | 1972 Dec. 0 | King |
| 5,013,981 | | 1991 May 0 | Rodi |
| 6,995,537 | | 2014 Aug. 0 | Dittmer |
| 11,018,612 | B1 | 2021 May 25 | Goche |
| 4,473,779 | A | 1984 Sep. 0 | Lindner |
| 5,465,040 | A | 1995 Nov. 0 | Yasotornrat |
| 6,525,490 | B1 | 2003 Feb. 0 | Rinaldi |
| 6,775,280 | B1 | 2004 Aug. 0 | Ma |
| 7,221,684 | B1 | 2007 May 0 | Smith |

### II. U.S. Patent Application Publications

| Publication No. | Kind Code | Date Published | Patentee |
|---|---|---|---|
| 20140253054 | A1 | 2014 Sep. 11 | Frampton et al. |
| 20150349598 | A1 | 2015 Dec. 3 | Gieras et al. |
| 20160204683 | A1 | 2016 Jul. 14 | Nordstrom et al. |
| 20160352204 | A1 | 2016 Dec. 1 | Li et al. |
| 20110260625 | A1 | 2011 Oct. 0 | Gautam |
| 20210320605 | A1 | 2021 Oct. 14 | Goche |
| 20160337878 | A1 | 2016 Nov. 0 | Frederiksen |

### III. Foreign Patent Documents

| | Kind | Country | | |
|---|---|---|---|---|
| Patent No. | Code | Code | Date Published | Patentee |
| 2021145864 | A1 | WO | 2021 Jul. 22 | Adventech, LLC |
| 2609605 | C | CA | 2006 Dec. 7 | Goche |
| 104038004 | A | CN | 2014 Oct. 9 | Frampton et al. |
| 2017070101 | A | JP | 2017 Jun. 4 | Keio et al. |
| 2559197 | C2 | RU | 2015 Oct. 8 | Golovan |
| 24416 | A | SI | 2014 Dec. 31 | Mandelj et al. |
| 2004001933 | A2 | WO | 2003 Dec. 31 | Goche |
| 2006130565 | A3 | WO | 2006 Dec. 7 | Goche |

### IV. Non-Patent Literature

WIKIPEDIA, “Current Density” https://en.wikipedia.org/wiki/Current_density/obtained
Jun. 21, 2022. 8 pages.
“What do All Those Things on an AC Motor Nameplate Mean?” Date unknown. 7 pages.
COWERN, Ed “Understanding Induction Motor Nameplate Information” Date unknown. 6
pages.
BHATIA, A., Understanding Motor Nameplate Information: NEMA vs. IEC Standards. Date
Unknown. 7 pages.
Understanding Electric Motor Nameplates. Copyright 2016, Biosystems & Agricultural
Engineering Department, Michigan State University. Date unknown. 13 pages.
NEMA vs. IEC Motor Standards Comparison and Contrast of the Two Design Practices. Date
unknown. 33 pages.
Redzione, High Efficiency motors and sustainability.
https://www.electricmotorengineering.com/high-efficiency-motors-and-s . . . Obtained Jan.
10, 2022. 12 pages.
NEMA Premium, Product Scope & Nominal Efficiency Levels. Updated Jun. 3, 2009. 4 pages.
Technical note, IEC 60034-30 standard on efficiency classes for low voltage AC motors. Date
unknown. 2 pages.
FACT SHEET Buying an Energy-Efficient Electric Motor. The energy savings network. Date
unknown. 8 pages.
FACT SHEET Determining Electric Motor Load and Efficiency. The energy savings network.
Date unknown. 16 pages.
BALDOR, Understanding NEMA Motor Nameplates. Date unknown. 40 pages.
ENERY EFFICIENCY HANDBOOK Toward Zero Emission. 513 High efficiency motors.
Date unknown. 4 pages.
ABB, High Voltage engineered induction motors. Technical Catalog. Copyright 2021. 164
pages.
NEMA Super-E Premium efficient motors. Copyright 2012. 64 pages.
Super Premium Efficiency IE4 Induction Motors. Date unknown. 3 pages.
Motor MEPS Guide; Zurich; 1^{st} Edition 2009. 19 pages.
How an Induction Motor Works by Equations (and Physics) Spring 207. 15 pages.
FINLEY and BURKE, “Proper Specification and Installation of Induction Motors” ISBN: 0-
7803-2909-0. Copyright 1995 IEEE. 13 pages.
NEMA A, B, C, and D Electrical Motor Design. The Engineering Toolbox.
https://www.engineeringtoolbox.com/nema-a-b-c-d-design-d_650.html. Obtained Jan. 10, 2022.
7 pages.
Electrical Induction Motors - Slip. The Engineering Toolbox.
https://www.engineeringtoolbox.com/electrical-motor-slip-d_652.html.
International PCT Patent Application No. PCT/US2020/013538, filed Jan. 14, 2020. Search
Report dated 29 May 2020. 4 pages.
International PCT Patent Application No. PCT/US2020/013538, filed Jan. 14, 2020. Written
Opinion dated 29 May 2020. 10 pages.
Power Management, Waveform audit: is your inductor saturated?
https://e2e.ti.com/blogs_/b/powerhouse/archive/2016/09/22/waveform-audit, Jul. 19, 2019, 4
pages
Wikipedia, Saturation (magnetic), https://en.wikipedia.org/wiki/Saturation_(magnetic), Jul.
19, 2019, 3 pages
Quora, What is inductor saturation current? https://www.quora.com/What-is-inductor-
saturation-current, Jul. 19, 2019, 4 pages
Circuit Digest, what is Inductor Coupling- Inductors in Series & Parallel Combinations,
https://circuitdigest.com/tutorial/what-is-inductor-coupling-series-and-parallel-combinations,
Jul. 19, 2019, 16 pages
International Application No. PCT/US20/13538 filed 14 Jan. 2020. First Named Inventor:
Goche

Thus, the applicant(s) should be understood to have support to claim and make claims to embodiments including at least: i) each of the induction motor devices as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such processes, methods, systems or components, ix) each system, method, and element shown or described as now applied to any specific field or devices mentioned, x) methods and apparatuses substantially as described hereinbefore and with reference to any of the accompanying examples, xi) an apparatus for performing the methods described herein comprising means for performing the steps, xii) the various combinations and permutations of each of the elements disclosed, xiii) each potentially dependent claim or concept as a dependency on each and every one of the independent claims or concepts presented, and xiv) all inventions described herein.

With regard to claims whether now or later presented for examination, it should be understood that for practical reasons and so as to avoid great expansion of the examination burden, the applicant may at any time present only initial claims or perhaps only initial claims with only initial dependencies. The office and any third persons interested in potential scope of this or subsequent applications should understand that broader claims may be presented at a later date in this case, in a case claiming the benefit of this case, or in any continuation in spite of any preliminary amendments, other amendments, claim language, or arguments presented, thus throughout the pendency of any case there is no intention to disclaim or surrender any potential subject matter. It should be understood that if or when broader claims are presented, such may require that any relevant prior art that may have been considered at any prior time may need to be re-visited since it is possible that to the extent any amendments, claim language, or arguments presented in this or any subsequent application are considered as made to avoid such prior art, such reasons may be eliminated by later presented claims or the like. Both the examiner and any person otherwise interested in existing or later potential coverage, or considering if there has at any time been any possibility of an indication of disclaimer or surrender of potential coverage, should be aware that no such surrender or disclaimer is ever intended or ever exists in this or any subsequent application. Limitations such as arose in Hakim v. Cannon Avent Group, PLC, 479 F.3d 1313 (Fed. Cir 2007), or the like are expressly not intended in this or any subsequent related matter. In addition, support should be understood to exist to the degree required under new matter laws—including but not limited to European Patent Convention Article 123 (2) and United States Patent Law 35 USC 132 or other such laws—to permit the addition of any of the various dependencies or other elements presented under one independent claim or concept as dependencies or elements under any other independent claim or concept. In drafting any claims at any time whether in this application or in any subsequent application, it should also be understood that the applicant has intended to capture as full and broad a scope of coverage as legally available. To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, if or when used, the use of the transitional phrases “comprising”, “including”, “containing”, “characterized by” and “having” are used to maintain the “open-end” claims herein, according to traditional claim interpretation including that discussed in MPEP § 2111.03. Thus, unless the context requires otherwise, it should be understood that the terms “comprise” or variations such as “comprises” or “comprising”, “include” or variations such as “includes” or “including”, “contain” or variations such as “contains” and “containing”, “characterized by” or variations such as “characterizing by”, “have” or variations such as “has” or “having”, are intended to imply the inclusion of a stated element or step or group of elements or steps but not the exclusion of any other element or step or group of elements or steps. Such terms should be interpreted in their most expansive form so as to afford the applicant the broadest coverage legally permissible. Further the language “selected from” should also be understood as supporting a narrower group-oriented/Markush language if necessary to be explicitly so limited such as have a group “consisting of” or “consisting essentially of” items a, b, and c, or the like.

The use of the phrase, “or any other claim” is used to provide support for any claim to be dependent on any other claim, such as another dependent claim, another independent claim, a previously listed claim, a subsequently listed claim, and the like. As one clarifying example, if a claim were dependent “on claim 9 or any other claim” or the like, it could be re-drafted as dependent on claim 1, claim 8, or even claim 11 (if such were to exist) if desired and still fall with the disclosure. It should be understood that this phrase also provides support for any combination of elements in the claims and even incorporates any desired proper antecedent basis for certain claim combinations such as with combinations of method, apparatus, process, and the like claims.

Finally, any claims set forth at any time are hereby incorporated by reference as part of this description of the various embodiments of the application, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

1. An improved reverse magnetic asynchronous induction motor system comprising:
at least one drive stator;
at least one reverse magnetic stator system;
at least one reverse stator capacitance having a size determined at least in part by the nameplate power and at least in part by the inverse cube of the nameplate voltage of a comparable supplied power but disparate motor type induction motor; and
a rotor.

2-3. (canceled)

4. An improved reverse magnetic asynchronous induction motor system as described in claim 1 wherein said at least one reverse magnetic stator system comprises at least one substantially drive stator magnetically coincident reverse stator winding.

5-10. (canceled)

11. An improved reverse magnetic asynchronous induction motor system as described in claim 1 wherein said at least one reverse stator capacitance comprises at least one reverse stator capacitance having a microfarad value substantially equal to a stepped variable multiplier stepping over a specific nameplate voltage range, times the frame's standard nameplate motor power in watts, times the inverse of a quantity equal to: the frame's standard nameplate motor voltage cubed, times the frame's standard nameplate motor efficiency as a decimal value, times the frame's standard nameplate motor power factor as a decimal value.

12. An improved reverse magnetic asynchronous induction motor system as described in claim 11 wherein said stepped variable multiplier comprises an about one hundred eighty-three thousand lower step multiplier value.

13. An improved reverse magnetic asynchronous induction motor system as described in claim 12 wherein said stepped variable multiplier comprises an about one million three hundred fifty-eight thousand upper step multiplier value.

14. An improved reverse magnetic asynchronous induction motor system as described in claim 13 wherein said stepped variable multiplier comprises a limited voltage range ramping variable multiplier comprising an about nine hundred volt lower ramp range value.

15. An improved reverse magnetic asynchronous induction motor system as described in claim 14 wherein said limited voltage range ramping variable multiplier comprises an about twenty-three hundred volt upper ramp range value.

16. (canceled)

17. An improved reverse magnetic asynchronous induction motor system as described in claim 6 wherein said at least one reverse stator capacitance comprises at least one exorbitantly-sized reverse magnetic effect-boosting capacitance.

18. (canceled)

19. An improved reverse magnetic asynchronous induction motor system as described in claim 1 wherein said at least one drive stator has a drive stator wire cross-sectional area, wherein said at least one reverse magnetic stator system has a reverse stator winding wire cross-sectional area, and wherein said stator winding wire cross-sectional area to reverse stator winding wire cross-sectional area establishes a ratio of about two.

20. An improved reverse magnetic asynchronous induction motor system as described in claim 1 wherein said at least one reverse magnetic stator system comprises at least one nearly joule effect breakdown current density reverse magnetic stator system.

21. An improved reverse magnetic asynchronous induction motor system as described in claim 1 wherein said improved reverse magnetic asynchronous induction motor system has a motor frame having a comparable motor standard nameplate efficiency value at a rated full load when said motor frame is used without said reverse magnetic stator system in said comparable motor, and wherein said improved reverse magnetic asynchronous induction motor system has constant power efficiency at its rated full load that improves upon said comparable motor standard nameplate efficiency value by an efficiency improvement selected from:
at least a 33% efficiency improvement over said comparable motor standard nameplate efficiency towards 100%;
at least a 40% efficiency improvement over said comparable motor standard nameplate efficiency towards 100%; and
at least a 50% efficiency improvement over said comparable motor standard nameplate efficiency towards 100%.

22-25. (canceled)

26. An improved reverse magnetic asynchronous induction motor system comprising:
at least one drive stator;
at least one high total motor-efficiency reverse magnetic stator system;
a rotor;
an induction motor system drive system; and
a motor frame.

27-30. (canceled)

31. An improved reverse magnetic asynchronous induction motor system as described in claim 27 wherein said improved reverse magnetic asynchronous induction motor system has a motor frame having a comparable motor standard nameplate efficiency value at a rated full load when said motor system motor frame is used without said reverse magnetic stator system in said comparable motor, and wherein said improved reverse magnetic asynchronous induction motor system has constant power efficiency at its rated full load that improves upon said comparable motor standard nameplate efficiency value by an efficiency improvement selected from:
at least a 20% efficiency improvement over said comparable motor standard nameplate efficiency towards 100%;
at least a 33% efficiency improvement over said comparable motor standard nameplate efficiency towards 100%;
at least a 40% efficiency improvement over said comparable motor standard nameplate efficiency towards 100%; and
at least a 50% efficiency improvement over said comparable motor standard nameplate efficiency towards 100%.

32. (canceled)

33. An improved reverse magnetic asynchronous induction motor system as described in claim 31 wherein said improved reverse magnetic asynchronous induction motor system has a motor frame having a comparable motor standard nameplate slip value at a rated full load when said motor system motor frame is used without said reverse magnetic stator system in said comparable motor, and wherein said improved reverse magnetic asynchronous induction motor system has constant power slip at its rated full load that improves upon said comparable motor standard nameplate slip value by a slip improvement selected from:
at least a 20% slip improvement over said comparable motor standard nameplate slip value towards zero slip;
at least a 50% slip improvement over said comparable motor standard nameplate slip value towards zero slip;
at least a 75% slip improvement over said comparable motor standard nameplate slip value towards zero slip;
at least a 90% slip improvement over said comparable motor standard nameplate slip value towards zero slip; and
at least a 95% slip improvement over said comparable motor standard nameplate slip value towards zero slip.

34. An improved reverse magnetic asynchronous induction motor system as described in claim 27 wherein said IE4-total motor-efficiency comprises substantially constant power efficiency.

35. (canceled)

36. An improved reverse magnetic asynchronous induction motor system as described in claim 26 wherein said motor system has a total motor efficiency at constant power, at 100% of its rated load, and wherein said total motor efficiency comprises a total motor efficiency selected from:
at least 98.5% efficiency for motors having rated full loads above 2 megawatts;
at least 99% efficiency for motors having rated full loads above 2 megawatts;
at least 98.5% efficiency for motors having rated full loads from 1 megawatt to 2 megawatts;
at least 99% efficiency for motors having rated full loads from 1 megawatt to 2 megawatts;
at least 98% efficiency for motors having rated full loads from 500 kilowatts to 1000 kilowatts;
at least 98.5% efficiency for motors having rated full loads from 500 kilowatts to 1000 kilowatts;
at least 97.5% efficiency for motors having rated full loads from 100 kilowatts to 500 kilowatts;
at least 98% efficiency for motors having rated full loads from 100 kilowatts to 500 kilowatts;
1 at least 97% efficiency for motors having rated full loads from 20 kilowatts to 100 kilowatts;
at least 97.5% efficiency for motors having rated full loads from 20 kilowatts to 100 kilowatts;
at least 96.5% efficiency for motors having rated full loads from 5 kilowatts to 20 kilowatts;
at least 97% efficiency for motors having rated full loads from 5 kilowatts to 20 kilowatts;
at least 96% efficiency for motors having rated full loads from 1 kilowatts to 5 kilowatts; and
at least 96.5% efficiency for motors having rated full loads from 1 kilowatts to 5 kilowatts.

37-40. (canceled)

41. An improved reverse magnetic asynchronous induction motor system comprising:
at least one drive stator;
at least one rated-full load slip-minimized reverse magnetic stator system; and
a rotor.

42. An improved reverse magnetic asynchronous induction motor system as described in claim 41 wherein said at least one rated-full load slip-minimized reverse magnetic stator system comprises at least one slip-minimized capacitance.

43. An improved reverse magnetic asynchronous induction motor system as described in claim 41 wherein said motor system has a motor frame having a comparable motor standard nameplate slip value at a rated full load when said motor frame is used without said reverse magnetic stator system in said comparable motor, and wherein said improved reverse magnetic asynchronous induction motor system has slip at its rated full load that improves upon said comparable motor standard nameplate slip value by at least a 20% slip improvement over that amount towards zero slip.

44-45. (canceled)

46. An improved reverse magnetic asynchronous induction motor system comprising:
at least one drive stator;
at least one reverse magnetic stator system;
at least one reverse stator capacitance having a size determined by a comparable supplied power but disparate motor type induction motor; and
a rotor.

47. An improved reverse magnetic asynchronous induction motor system comprising:
at least one drive stator;
at least one drive stator-coordinated reverse magnetic stator system;
a rotor; and
a motor frame encasing at least said at least one drive stator and said rotor.

48. An improved reverse magnetic asynchronous induction motor system comprising:
at least one drive stator;
at least one nearly joule effect breakdown current density reverse magnetic stator system; and
a rotor.

49. An improved reverse magnetic asynchronous induction motor system comprising:
at least one drive stator having at least one drive stator reactance;
at least one reverse magnetic stator system;
at least one exorbitantly-sized reverse magnetic effect-boosting capacitance;
a rotor; and
a motor frame.

50. An improved reverse magnetic asynchronous induction motor system comprising:
at least one drive stator;
at least one at least IE4-total motor-efficiency reverse magnetic stator system;
a rotor;
an induction motor system drive system; and
a motor frame.

51. An improved reverse magnetic asynchronous induction motor system comprising:
at least one drive stator;
at least one at least NEMA super premium total motor-efficiency reverse magnetic stator system;
a rotor;
an induction motor system drive system; and
a motor frame.

52. A method of providing power from an asynchronous induction motor system comprising the steps of:
powering at least one drive stator;
powering at least one drive stator-coordinated reverse magnetic stator system; and
rotating a rotor with interaction of said at least one drive stator and said at least one drive stator-coordinated reverse magnetic stator system.

53. A method of providing power from an asynchronous induction motor system comprising the steps of:
providing an induction motor system drive system;
powering at least one drive stator;
powering at least one at least IE4-total motor-efficiency reverse magnetic stator system;
rotating a rotor with interaction of said at least one drive stator and said at least one high efficiency reverse magnetic stator system;
encasing said drive stator, a reverse magnetic stator, and said rotor;
achieving at least IE4-total motor-efficiency by said motor system as compared to said comparable motor.

54. A method of providing power from an asynchronous induction motor system comprising the steps of:
powering at least one drive stator;
powering at least one rated-full load slip-minimized reverse magnetic stator system; and
rotating a rotor with interaction of said at least one drive stator and said at least one rated-full load slip-minimized reverse magnetic stator system.

55. A method of providing power from an asynchronous induction motor system comprising the steps of:
powering at least one drive stator;
powering at least one nearly joule effect breakdown current density reverse magnetic stator system; and
rotating a rotor with interaction of said at least one drive stator and said at least one nearly joule effect breakdown current density reverse magnetic stator system.

56. A method of providing power from an asynchronous induction motor system comprising the steps of:
powering at least one drive stator;
powering at least one reverse magnetic stator;
effecting power to said at least one reverse magnetic stator by at least one exorbitantly-sized reverse magnetic effect-boosting capacitance; and
rotating a rotor with interaction of said at least one drive stator and said at least one reverse magnetic stator.

57. A method of providing power from an asynchronous induction motor system comprising the steps of:
powering at least one drive stator;
powering at least one reverse magnetic stator;
effecting power to said at least one reverse magnetic stator by at least one reverse stator capacitance having a size determined by a comparable supplied power but disparate motor type induction motor; and
rotating a rotor with interaction of said at least one drive stator and said at least one reverse magnetic stator.

58. An improved reverse magnetic asynchronous induction motor system comprising:
at least one drive stator;
at least one reverse magnetic stator system;
at least one reverse stator capacitance having a size indicated below as MED in micro farads (uF) as set forth in the following tables

| | |
|---|---|
| 460 Volts 60 Hz | 400 Volts 50 Hz |
| HP | MFD/Ph. | HP | MFD/Ph. |
|---|---|---|---|
| 5 | 9.90 | 4 | 15.55 |
| 7.5 | 14.10 | 5.5 | 21.02 |
| 10 | 18.30 | 7.5 | 28.76 |
| 15 | 28.65 | 11 | 26.97 |
| 20 | 37.50 | 15 | 54.75 |
| 25 | 48.00 | 18.5 | 67.84 |
| 30 | 54.30 | 22 | 79.74 |
| 40 | 72.75 | 30 | 106.32 |
| 50 | 88.5 | 37 | 130.53 |
| 60 | 108.00 | 45 | 160.88 |
| 75 | 132.00 | 55 | 192.42; |

and
a rotor.

59. An improved reverse magnetic asynchronous induction motor system comprising:
at least one drive stator;
at least one drive stator-coordinated reverse magnetic stator system capacitance having a size indicated below as MFD in micro farads (uF) as set forth in the following tables

| | |
|---|---|
| 460 Volts 60 Hz | 400 Volts 50 Hz |
| HP | MFD/Ph. | HP | MFD/Ph. |
|---|---|---|---|
| 5 | 9.90 | 4 | 15.55 |
| 7.5 | 14.10 | 5.5 | 21.02 |
| 10 | 18.30 | 7.5 | 28.76 |
| 15 | 28.65 | 11 | 26.97 |
| 20 | 37.50 | 15 | 54.75 |
| 25 | 48.00 | 18.5 | 67.84 |
| 30 | 54.30 | 22 | 79.74 |
| 40 | 72.75 | 30 | 106.32 |
| 50 | 88.5 | 37 | 130.53 |
| 60 | 108.00 | 45 | 160.88 |
| 75 | 132.00 | 55 | 192.42; |

a rotor; and
a motor frame encasing at least said at least one drive stator and said rotor.
